(19) United States
(12) Patent Application Publication
(10) Pub. No.: US 2025/0002420 A1
(43) Pub. Date: Jan. 2, 2025

(54) ALKALI METAL POLYBORATE SILICATE COATING FOR ACOUSTICAL PANEL AND GYPSUM BOARD

(71) Applicant: USG INTERIORS, LLC, Chicago, IL (US)

(72) Inventors: Dong Guo, Buffalo Grove, IL (US); Qinghua Li, Rolling Meadows, IL (US)

(73) Assignee: USG INTERIORS, LLC, Chicago, IL (US)

(21) Appl. No.: 18/625,779

(22) Filed: Apr. 3, 2024

Related U.S. Application Data
(60) Provisional application No. 63/511,370, filed on Jun. 30, 2023.

(51) Int. Cl. C04B 41/50; C04B 41/45

(52) U.S. Cl. CPC C04B 41/5006; C04B 41/4539; C04B 41/5024

(57) ABSTRACT

A coating composition for improving the sag resistance of a gypsum panel or a fibrous panel, the composition including 25 to 100 wt. % alkali metal polyborate silicate inorganic binder, based on the total weight of the dry coating. The inorganic binder includes alkali metal polyborate silicate resulting from combining alkali metal polyborate and alkali metal silicate. Further provided are fibrous panels having a backing side and an opposing facing side including a coating of the inorganic binder, and methods of preparing same. Further provided are gypsum panels having a backing side and an opposing facing side including a coating of the inorganic binder, and methods of preparing same.

### FIELD OF THE INVENTION

The disclosure relates generally to a building panel, such as a fibrous panel (acoustical panel) or a gypsum board, coated with a coating composition comprising a cured binder comprising alkali metal polyborate silicate, and methods of making same. More particularly, the alkali metal polyborate silicate results from curing a mixture of an inorganic alkali metal polyborate and an inorganic alkali metal silicate dissolved in water. Typically the mixture of the inorganic alkali metal polyborate and the inorganic alkali metal silicate dissolved in water is a transparent solution. Optionally the alkali metal polyborate silicate binder is applied to the building panel as suspension of inert filler particles suspended in the aqueous solution of alkali metal polyborate and alkali metal silicate.

### BACKGROUND OF THE INVENTION

Acoustical panels (or tiles) are specially designed systems that are intended to improve acoustics by absorbing sound and/or reducing sound transmission in an indoor space, such as a room, hallway, conference hall, or the like. Although there are numerous types of acoustical panels, a common variety of acoustical panel is generally composed of mineral wool fibers, fillers, colorants and a binder, as disclosed, for example, in U.S. Pat. No. 1,769,519. These materials, in addition to a variety of others, can be employed to provide acoustical panels with desirable acoustical properties and other properties, such as color and appearance.

In order to prepare acoustical panels, fibers, fillers, bulking agents, binders, water, surfactants and other additives are typically combined to form a slurry and processed. Cellulosic fibers are typically in the form of recycled newsprint. The bulking agent is typically expanded perlite. Fillers may include clay, calcium carbonate or calcium sulfate. Binders may include starch, latex and reconstituted paper products linked together to create a binding system that facilitates locking all ingredients into a desired structural matrix.

Organic binders, such as starch, are often the primary binder component providing structural adhesion for the panel. Starch is a preferred organic binder because, among other reasons, it is relatively inexpensive. For example, panels containing newsprint, mineral wool and perlite can be bound together economically with the aid of starch. Starch imparts both strength and durability to the panel structure, but is susceptible to problems caused by moisture. Moisture can cause the panel to soften and sag, which is unsightly in a ceiling and can lead to the weakening of the panel.

One method used to counter problems caused by moisture in panels is to provide a method of coating a fibrous panel comprising providing a fibrous panel comprising a backing side and an opposing facing side, and depositing a first coating layer on at least one side of the fibrous panel, the first coating layer comprising an inorganic binder, wherein the inorganic binder is present in an amount between about 10 and 100 wt. %, based on the total weight of the dry first coating layer, the inorganic binder comprises a borate salt and a metal silicate selected from the group consisting of an alkali metal silicate, an alkaline earth metal silicate, and combinations thereof, and the inorganic binder is water soluble as disclosed in published patent application no. US 2019/0382589 A1 to Li et al.

US 2019/0382589 A1 to Li et al. also provides a curable coating composition for improving the sag resistance of a fibrous panel, the curable coating composition comprising about 10 to 100 wt. % inorganic binder, based on the total weight of a dry coating formed therefrom, wherein the inorganic binder comprises a borate salt and a metal silicate selected from the group consisting of an alkali metal silicate, an alkaline earth metal silicate and combinations thereof, and the inorganic binder is water soluble. A disadvantage of US 2019/0382589 A1 to Li et al. is that if the borate salt concentration is raised too much then the composition is not transparent at room temperature (about 20° C.) due to precipitation of the boron-continuing compound.

Products made of gypsum (calcium sulfate dihydrate; CaSO4·2H2 O) are generally manufactured by combining stucco, also known as calcined gypsum (calcium sulfate hemihydrate; CaSO₄·½H₂O), with water and other ingredients as desired (such as foaming agent and other additives). Gypsum can be naturally found or synthetically developed and then calcined to make the stucco. The stucco, water, and other additives are normally combined in a mixer, at a “wet end” of a manufacturing line. The resulting slurry is set into a desired shape of a product, such as gypsum board (sometimes called “drywall”). It is the rehydration reaction of the slurry with water that forms set gypsum. Board is sometimes referred to as “panels” in the art. Gypsum wallboard normally has a sandwich structure with the core formed from the slurry placed between two cover sheets (e.g., made of paper or other material). A dense layer (sometimes called a “bonding layer”) can be placed between the core and the cover sheet on either or both of the top and bottom surfaces of the core to enhance paper/core bond.

Board normally has two cover sheets on either side of the core. A top cover sheet is for the “face” side of the board as that side is normally facing out and can be decorated, e.g., with paint. The bottom cover sheet is for the “back” side of the board as it is normally not visible when mounted as that surface normally faces inward, toward studs or other framing. Board is normally manufactured upside down, with the face side down at the wet end of the manufacturing line, although the board can be flipped later in the process. The slurry is normally formed on a conveyor to form a long, continuous ribbon. The slurry forming the ribbon begins to set on the conveyor as the calcium sulfate hemihydrate (stucco) reacts with water to form calcium sulfate dihydrate (gypsum). The ribbon is cut one or more times, dried in a kiln, and finally processed at the “dry end” of the manufacturing line.

Wallboard containing gypsum is widely used for interior wall and ceiling surfaces.

US published patent application No. 2020/0392050 A1 to Li et al. discloses an organic binder-based coating; a composite gypsum board containing face and back cover sheets, an outside surface of the back cover sheet bearing the coating; and a method of preparing composite board where the back cover sheet contains the coating on its outer surface. The coating is formed from a composition comprising an alkaline silicate, a solid filler, and optionally, a borate. An enhancing layer can also be applied to the back cover sheet.

US20010037035-A1 to Kutcel discloses methods for producing suspensions and/or granular products of polyborates. Methods for making suspensions of both insoluble and soluble polyborates are also disclose. Additionally, uses for such polyborate suspensions and/or granular products are also disclosed.

It will be appreciated that this background description has been created by the inventors to aid the reader, and is neither a reference to prior art nor an indication that any of the indicated problems were themselves appreciated in the art. While the described principles can, in some regards and embodiments, alleviate the problems inherent in other systems, it will be appreciated that the scope of the protected innovation is defined by the attached claims, and not by the ability of the claimed invention to solve any specific problem noted herein.

### BRIEF SUMMARY OF THE INVENTION

One aspect of the present disclosure provides a coated building panel comprising a fibrous panel or a gypsum wallboard comprising a backing side and an opposing facing side and having a cured coating layer disposed on at least one side of the building panel;
the fibrous panel, for example an acoustical panel, comprising the backing side and the opposing facing side;
the gypsum board having a gypsum core and the backing side comprising a back fibrous cover sheet and the opposed facing side comprising a front cover sheet, wherein the gypsum core is between the front fibrous cover sheet and the back fibrous cover sheet;
the cured coating layer comprising about 25 to 100 wt. %, preferably 30-100 wt. %, more preferably 30-80 wt. %, alkali metal polyborate silicate inorganic binder, based on the total dry weight of the cured coating.

The gypsum wallboard comprising a gypsum wallboard having a set gypsum core, a fibrous front cover sheet (facer) and fibrous back cover sheet (backer). The inorganic binder comprises alkali metal polyborate silicate binder resulting from a mixture of an alkali metal polyborate and an alkali metal silicate dissolved in water.

Another aspect of the disclosure provides a method of coating a building panel, selected from a fibrous panel or a gypsum wallboard, comprising the steps of:
providing the building panel comprising a backing side and an opposing facing side, and
depositing a first coating layer of an aqueous coating composition comprising an inorganic alkali metal polyborate silicate binder dissolved in water on at least one side of the building panel, the inorganic alkali metal polyborate silicate binder comprising a mixture of an inorganic alkali metal polyborate and an inorganic alkali metal silicate,
curing the coating layer of the aqueous coating composition comprising the inorganic alkali metal polyborate silicate binder to form a cured coating layer comprising the inorganic alkali metal polyborate silicate binder;
the cured coating layer comprising about 25 to 100 wt. %, preferably 30-100 wt. %, more preferably 30-80 wt. %, alkali metal polyborate silicate inorganic binder, based on the total dry weight of the cured coating.

Typically the inorganic alkali metal polyborate silicate binder is dissolved in water coating as a clear (transparent) solution when applied and when cured. However, the aqueous coating composition may be provides as a suspension that further includes particles of inert filler, for example clay, suspended in the clear (transparent) solution when applied and when cured.

The alkali metal polyborate silicate coating of the invention can be applied directly to the building panel or applied as a second coating on a first coating of alkali metal silicate coating. Or the alkali metal polyborate coating composition can blended with an alkali metal silicate coating composition to make a combined coating composition for application to a building panel. Or the alkali metal polyborate coating composition and the alkali metal silicate coating composition can be applied separately to a building panel while both are not yet cured, and thus still contain water, to make a combined alkali metal polyborate silicate coating composition on the building panel.

Typically the cured coating composition improves the sag resistance of the building panel. Surprising and unexpectedly, sag resistance in the fibrous panel and the gypsum wallboard can be enhanced by the use of the inorganic binder-based coating applied on an outer surface of a back cover sheet of the board. The inorganic binder-based coating comprises an alkali metal polyborate and a metal silicate selected from the group consisting of alkali metal silicates, alkaline earth metal silicates, and combinations thereof, and the inorganic binder is water soluble. Optionally, an enhancing layer can be applied to the back of the fibrous panel or the back cover sheet (e.g., over the inorganic binder-based coating) of the gypsum wallboard to further enhance sag resistance.

The disclosure further provides methods of coating building panels comprising a fibrous panel or gypsum wallboard panel with curable coating compositions for improving the sag resistance of building panels.

Optionally the coating composition has an absence of aluminum compound. For example, the coating composition has an absence of an absence of aluminum oxide and an absence of an absence of aluminum oxide precursor compound.

Optionally the coating composition has an absence of cyclic amines. Thus, the boric acid is not reacted with cyclic amines to make the polyborate.

Optionally the coating composition when applied and when cured has an absence of an acid, other than residual boric acid, if present. Preferably the coating composition when applied and when cured has less than 2 wt. % boric acid, more preferably less than 1 wt. % boric acid, most preferable no boric acid. Here in the description an acid means an acid defined in Bronsted-Lowrey acid base theory and means a substance donating protons.

Advantages of the present invention may become apparent to those having ordinary skill in the art from a review of the following detailed description, taken in conjunction with the examples, and the appended claims. It should be noted, however, that while the invention is susceptible of various forms, the present disclosure is intended as illustrative, and is not intended to limit the invention.

That is, any aqueous solvent used to mix the inorganic binders of the disclosure, such as water and the like, that may have been present in the coating composition has been evaporated or dehydrated through heating, chemical curing, or any other process suitable for drying a coated fibrous panel.

### BRIEF DESCRIPTION OF THE DRAWINGS

FIG. 1 schematically illustrates a perspective view of a coated acoustical panel having a coating according to an embodiment of the disclosure.

FIG. 1A schematically illustrates a perspective view of a coated acoustical panel having a coating according to a second embodiment of the disclosure.

FIG. 2 shows a cross-sectional view of a gypsum board of the invention, in which a board core (gypsum core) is sandwiched between a front paper cover sheet and a back paper cover sheet, the back paper cover sheet coated with a polymer layer.

FIG. 3 shows a perspective view of a gypsum board of the present invention attached to one side of a metal stud wall suitable in a wall system of the present invention.

### DETAILED DESCRIPTION OF THE INVENTION

For purposes of this disclosure a dry basis is a water free basis. A wet basis is a water inclusive basis.

All average molecular weights, percentages and ratios used herein, are by weight (i.e., wt. %) unless otherwise indicated.

As used herein for acoustical tile, the terms “panel” and “tile” should be considered interchangeable. Similarly, the terms “fibrous panel,” “acoustical panel”, “ceiling tile,” and “acoustical tile” should be considered interchangeable.

As used herein for gypsum wallboard, the terms “panel” and “board” should be considered interchangeable. Also, the terms “front cover sheet” and “facer” should be considered interchangeable. Also, the terms “back cover sheet” and “backer” should be considered interchangeable.

As used herein, the terms “coating composition” and “coating layer” should be considered interchangeable, insomuch as the coating layer is used to refer to the coating composition when applied or deposited on the fibrous panel. As used herein, the term “dry coating,” “dry coating layer,” or “cured coating layer” can be used interchangeably to refer to the final coating on a coated fibrous panel after any drying and/or curing steps are carried out. Generally, during curing, coatings change from the liquid to solid state due to evaporation of the solvent and/or because of physical and/or chemical reactions of the binder media. Thus, curing encompasses drying and/or cross-linking.

The disclosure provides a coated building panel comprising a fibrous panel or a gypsum wallboard comprising a backing side and an opposing facing side and having a cured coating layer disposed on at least one side of the building panel;
the fibrous panel comprising the backing side and the opposing facing side;
the gypsum board having a gypsum core and the backing side comprising a back fibrous cover sheet and the opposed facing side comprising a front cover sheet, wherein the gypsum core is between the front fibrous cover sheet and the back fibrous cover sheet;
the cured coating layer comprising about 25 to 100 wt. %, preferably 30-100 wt. %, more preferably 30-80 wt. %, alkali metal polyborate silicate inorganic binder, based on the total dry weight of the cured coating.

Typically, the coating layer is free or substantially free of formaldehyde and free or substantially free of organic polymeric binder(s). Similarly, typically in embodiments, the inorganic binder is free or substantially free of formaldehyde and free or substantially free of organic polymeric binder(s).

Alternatively, in embodiments, the coating layer includes additional binders, including, but not limited to, organic polymeric binders or is free of additional binders.

As used herein, “substantially free of formaldehyde” means that the coating layer and/or binder is not made with formaldehyde or formaldehyde-generating chemicals and will not release formaldehyde under normal service conditions. The term “substantially free of formaldehyde” can be further defined as meaning free of intentionally or purposely added formaldehyde, such that an incidental or background quantity of formaldehyde (e.g., less than 100 ppb) may be present in the coating composition.

As used herein, “substantially free of an organic polymeric binder” means that the inorganic binder does not contain an organic polymeric binder and that the coating composition including the inorganic binder also does not contain significant amounts of purposely added organic polymeric binder. Thus, incidental or background quantity of organic polymer binder (e.g., less than about 100 ppb) may be present in the coating compositions according to the disclosure (e.g., that leached out of the panel core material) and be within the scope of the disclosure. As used herein “organic polymeric binder” includes organic polymers and oligomers and further includes organic monomers that can polymerize in situ (with or without curing) to form an organic polymer.

The invention also relates to building panels, for example fibrous panels, such as for acoustic ceiling tile, or gypsum wallboard, coated with this aqueous coating containing alkali metal polyborate silicate binder in solution. The aqueous coating is applied to the acoustic ceiling tiles or gypsum wallboard, dried and cured at relatively low temperatures to form coated building panel products. Thus, the invention provides acoustic ceiling tile or gypsum wallboard coated with this aqueous coating to form a hard and water resistant protective coating. The curable coating composition can improve the sag resistance of the fibrous panel or gypsum wallboard.

Advantageously, the coating comprising alkali metal polyborate silicate binder improves sag resistance of a building panel to have 10 to 60%, for example 20 to 35%, less sag as measured by ASTM C367M-09 than the same building panel coated with inorganic binder comprising the alkali metal silicate, but no alkali metal polyborate and no alkali metal borate, provided in the same amount as the total of the alkali metal silicate and alkali metal polyborate of the coating comprising alkali metal polyborate silicate binder.

### Aqueous Alkali Metal Polyborate Silicate Inorganic Binder Mixture

The present invention typically provides an aqueous inorganic binder mixture comprising alkali metal polyborate silicate formed from a mixture of alkali metal polyborate and alkali metal silicate (e.g., sodium silicate or water glass) dissolved in water. The aqueous inorganic binder mixture is typically a clear coating solution of the mixture of alkali metal polyborate and alkali metal silicate.

The curable aqueous coating composition includes about 25 to 100 wt. %, preferably 30-100 wt. %, more preferably 30-80 wt. %, inorganic binder (alkali metal polyborate silicate formed from a mixture of alkali metal polyborate and alkali metal silicate), based on the total weight of the dry coating.

In particular, the cured (dry) coating composition comprises a mixture of alkali metal polyborate and alkali metal silicate, wherein the alkali metal polyborate is 5 to 50%, typically 10 to 50 wt. %, more typically 10-30 wt. %, of the total of the alkali metal polyborate and the alkali metal silicate.

Typically the inorganic binder includes a mixture of sodium silicate and sodium polyborate made from boric acid and sodium tetraborate.

The aqueous inorganic binder mixture is applied to a building panel. The alkali metal polyborate silicate dissolved in water in the aqueous inorganic binder mixture then dries and/or crosslinks to form the solid coating on the building panel. In the present disclosure the term cured is interchangeable with the terms dried and/or crosslinked.

The cured alkali metal polyborate silicate layer homogenously distributes the alkali metal polyborate and alkali metal silicate in the coating layer.

The alkali metal polyborate is made by mixing alkali borate and boric acid to make polyborate at high temperature in a range of 80 to 90° C., for example 85 to 90° C. The making of alkali metal polyborate solution is described in more detail elsewhere in this disclosure, for example in the section entitled Alkali Metal Polyborate. The polyborate permits the high borate concentration to be stable at ambient (room) temperature (typically about 25° C.). In other words, once the polyborate forms its solution is stable. Preferably the invention aqueous solution has a 20-30 wt. % polyborate concentration. The aqueous solution of the alkali metal polyborate has long term stability and shows no precipitations at room temperature (about 25° C.). It is sufficiently stable to be kept at room temperature for at least 3, preferably 3 to 9 months.

The produced solution of alkali metal polyborate is then mixed with alkali metal silicate typically at room temperature to make a solution of alkali metal polyborate silicate. The aqueous inorganic binder mixture, which is the solution of alkali metal polyborate silicate, is a room temperature stable clear aqueous solution that has long term stability and shows no precipitations at room temperature. It is sufficiently stable to be kept at room temperature for at least 3, preferably 3 to 9, months.

If desired the alkali metal polyborate solution may be made by reacting alkali metal borate and boric acid at high temperature in a range of 80 to 90° C., for example 85 to 90° C., remains at a temperature in the range from 40-80° C. and, while still at the temperature in the range from 40-80° C., it is combined with the alkali metal silicate.

If one skilled in the art were to use only sodium silicate on an acoustic panel or gypsum wallboard it provides strength under normal conditions, but loses strength when exposed to humidity. This causes sag.

Adding the high amounts of boron provided from alkali metal polyborate, such that the dry coating composition comprises a mixture of alkali metal polyborate and alkali metal silicate, wherein the alkali metal polyborate is 5 to 50%, typically 10 to 50 wt. %, more typically 10-30 wt. %, of the total of the alkali metal polyborate and the alkali metal silicate, makes the coating stronger and more water resistant. The Si and B combine to form a chemical structure that is more water resistant than a sodium silicate coating because the boron combines with the silicon to result in less free silicon to combine with the water from the humidity. Thus, the inventive coating maintains its strength when exposed to humidity. This results in better sag resistance for the building panel products.

Optionally, the clear aqueous inorganic binder mixture that comprises the dissolved alkali metal polyborate silicate may be combined with other ingredients, for example inert clay particles to form a suspension of the dissolved alkali metal polyborate silicate with the suspended inert clay particles for application to the building panel as a coating.

Optionally, the coating according to the disclosure is substantially free of additional inorganic binders. That is, in embodiments, the inorganic binders of the coating are substantially free of non-polyborate salt binders, and substantially free of non-alkali metal silicate binders. As used herein “substantially free of non-polyborate salt binders,” and “substantially free of non-alkali metal silicate binders,” means that the coating does not contain significant amounts of purposely added non-polyborate salt binders, or non-alkali metal silicate binders. For example, less than 3 wt. %, less than 2 wt. %, or less than 1 wt. %, based on the total weight of the dry coating, may be present in the coating and be within the scope of the disclosure. Thus, in embodiments, the inorganic binder according to the disclosure can consist of, or consist essentially of, one or more alkali polyborates and one or more alkali metal silicates.

Optionally, the coating according to the disclosure is “substantially free of alkaline earth polyborates” or “substantially free of alkaline earth metal silicates”. As used herein substantially free of “alkaline earth polyborates” or “substantially free of alkaline earth metal silicates,” means that the coating does not contain significant amounts of purposely added alkaline earth polyborates or alkaline earth metal silicates. For example, less than 3 wt. %, less than 2 wt. %, or less than 1 wt. %, based on the total weight of the dry coating, may be present in the coating and be within the scope of the disclosure.

Optionally, the coating according to the disclosure is substantially free of organic binders. Preferably, the composition is substantially free of a latex compound such as polyvinyl acetate, styrene butadiene, polyvinyl alcohol, or polyethylene. In addition, it is preferable that the composition is substantially free of a magnesium compound such as magnesium chloride or magnesium oxide. As used herein, “substantially free” can mean either (i) 0 wt. % based on the weight of the composition, or (ii) an ineffective or (iii) an immaterial amount of latex or magnesium compound. An example of an ineffective amount is an amount below the threshold amount to achieve the intended purpose of using such latex or magnesium compound, as one of ordinary skill in the art will appreciate. An immaterial amount may be, e.g., below about 1 wt. %, below about 0.5 wt. %, below about 0.2 wt. %, below about 0.1 wt. %, or below about 0.01 wt. %, as one of ordinary skill in the art will appreciate.

### Alkali Metal Polyborate

A polyborate for purposes of the present disclosure is a compound comprising multiple borate anions to have boron numbers (boron atoms) of at least 5, or typically at least 7, typically 5 to 20, or typically 5 to 18, or typically 5 to 15, or typically 7 to 20, or typically 75 to 18, or typically 7 to 15.

Alkali Polyborates are a class of inorganic compound (salt) containing boron atoms within their anionic moieties. These boron atoms are bound solely to oxygen and can adopt either trigonal-planar or tetrahedral connectivity. The cations of these salts can be “naked” metals (e.g., Na⁺), organic, or transition-metal complexes and furthermore, polyborates may also be anhydrous or hydrated. Such alkali polyborates include, but are not limited to, disodium octaborate tetrahydrate (Na₂B₈O₁₃·4H₂O or Na₂O·4B₂O₃·4H₂O), and sodium pentaborate decahydrate (Na₂O·5B₂O₃·10H₂O). Sodium polyborates may have a Na20/B203 molar ratio of about 0.1 to about 0.4, typically about 0.2 to 0.3. Disodium octaborate tetrahydrate has a molar ratio of Na₂O/B₂O₃ of 0.25. Sodium pentaborate decahydrate, which has a molar ratio of Na₂O/B₂O₃ of 0.20.

Typically alkali metal borate salt is reacted with boric acid to make concentrated solutions of alkali metal polyborate. Any boric acid and any water soluble alkali metal borate salt are considered suitable for reacting to make the polyborate salts for the coating composition of the disclosure.

Typical boric acids include, for example orthoboric acid H₃BO₃, meta-boric acid HBO₂, tetra-boric acid B₄H₂O₇, pyroboric acid H₂B₄O₉, boron oxide B₂O₃, or other oxoacids of boron (boric acid). Among these, one or two or more types in combination may be used. Among these, tetra-boric acid or orthoboric acid are preferred.

Typical alkali metal borate salt include, for example, sodium metaborate, sodium tetraborate, potassium tetraborate, lithium tetraborate, potassium pentaborate, ammonium pentaborate, 5 mole borax (Na₂B₄O₇5H₂O), 10 mole borax (Na₂B₄O₇·10H₂O, also known as borax decahydrate or sodium tetraborate decahydrate), boric oxide, lithium borate, and combinations thereof. Typically, the borate salt of an alkali metal contains sodium tetraborate or potassium tetraborate. Preferably the borate salt comprises borax (Na₂[B₄O₅(OH)₄·8H₂O). Among these, single types alone or two or more types in combination may be used. The alkali metal borate salt can be an anhydrous alkali metal borate salt or a hydrated alkali metal borate salt. For example, sodium tetraborate encompasses anhydrous sodium tetraborate, sodium tetraborate pentahydrate, or mixtures thereof.

The alkali metal of the borate salt is not particularly limited. Lithium, sodium, potassium, rubidium, cesium, and francium may be mentioned. Among these, one or two or more types in combination may be used. Among these, sodium and potassium are preferred. Typically the alkali metal is sodium.

US20010037035-A1 to Kutcel discloses that generally, sodium polyborates are produced by reacting boric acid (H₃BO₃) with either 5 mole borax (Na₂B₄O₇5H₂O) or 10 mole borax (Na₂B₄O₇·10H₂O, also known as borax decahydrate or sodium tetraborate decahydrate). The sodium polyborates which are produced by such a method include, but are not limited to, disodium octaborate tetrahydrate (DOT) and sodium pentaborate decahydrate. US. US20010037035-A1 to Kutcel discloses that this method is disclosed in Boron, Metallo-Boron Compounds and Boranes, Roy M. Adams (editor), Interscience Publishers, 1964, pp. 98-109.

See also methods to react alkali borate and boric acid to make concentrated solutions of polyborate disclosed by Tsuyumoto, et al., Preparation of highly concentrated aqueous solution of sodium borate, Inorganic Chemistry Communications 10 (2007) 20-22. Tsuyumoto, et al. discloses to use the concentrated solutions of polyborate as fireproofing agents.

For example, a sodium polyborate aqueous solution for use in the invention may be made by mixing boric acid and sodium tetra-borate in a weight ratio of 1:1.25, making them completely dissolve in 80° C. or more in water, then cooling down to room temperature (25±15° C.) to obtain the sodium polyborate aqueous solution.

A typical Sodium/Boron weight ratio to obtain the aqueous solution having 20-30 wt. % polyborate concentration is in a range of 0.19-0.40, preferably 0.22-0.27 (5.24 to 6.62 mol/kg of boron).

Using this method, it is possible to obtain an aqueous solution containing polyborate as a boron source with a higher borate concentration, for example an aqueous solution that has a 20-30 wt. % polyborate concentration that is stable at room temperature (about 20-25° C.). In other words, an aqueous solution that has a 20-30 wt. % polyborate concentration that remains transparent at room temperature.

In contrast, mixing the alkali borate and Boric acid at room temperature cannot arrive at aqueous solutions having a 20-30 wt. % borate concentration that is stable at room temperature. Also, mixing alkali borate, for example sodium borate, alone with water, even if the mixing is at elevated temperature, cannot achieve aqueous solutions having a 20-30 wt. % borate concentration that is stable at room temperature. Trying to raise the concentration of borate by just mixing an alkali metal borate (not a polyborate as in the invention) alone in water without using Boric acid, results in the presence of excess unreacted borate remaining in the aqueous solution that precipitates and results in a cloudy coating. Likewise, mixing Boric acid alone with water, even at elevated temperature, cannot achieve a composition having a 20-30 wt. % borate concentration that is stable at room temperature. Boric acid has a low solubility with respect to water. Trying to raise the concentration of Boric acid by just boric acid without an alkali metal borate, results in undissolved boric acid remaining in the aqueous solution that precipitates and results in a cloudy coating.

The alkali metal polyborate is typically made by reacting boric acid and alkali metal borate at selected conditions and amounts to get at least 80 wt. %, typically at least 90 wt. % or at least 95 wt. %, more preferably at least 98 wt. %, furthermore preferably at least 99 wt. %, and most preferably 100 wt. % conversion (yield) of boric acid. The alkali metal polyborate is made by reacting boric acid and sodium borate at selected conditions and concentrations to get at least 80 wt. %, typically at least 90 wt. % or at least 95 wt. %, more preferably at least 98 wt. %, furthermore preferably at least 99 wt. %, and most preferably 100 wt. % conversion (yield) of alkali metal borate to polyborate.

The coating composition can be made an aqueous solution with no undissolved boric acid present. Also, the coating composition can be made an aqueous solution with no undissolved borate present. Having low or no amounts of no residual alkali borate or residual boric acid present is beneficial because residual alkali borate or residual boric acid would precipitate and/or make the solution cloudy (not clear) so it less able to be mixed with a source of silicon oxide such as alkali metal silicate.

### Alkali Metal Silicate

The inorganic binder of the disclosure further includes alkali metal silicate. Any water soluble metal silicate and combinations thereof may be included in the coating compositions of the disclosure. Specific alkali metal silicates include, but are not limited to, sodium silicate, potassium silicate, lithium silicate, magnesium silicate, calcium silicate, beryllium silicate, and combinations thereof. Typically, the alkali metal silicate includes sodium silicate or potassium silicate. More typically, the alkali metal silicate includes sodium silicate.

Sodium silicate is a generic name for inorganic chemical compounds with the formula Na₂ₓSi_{y}O_{2y+x} or (Na₂O)ₓ·(SiO₂)_{y}, Sodium silicate solutions may also be referred to as “waterglass” and have a nominal formula Na₂O(SiO₂)x. Commercially available sodium silicate solutions have a weight ratio of SiO₂:Na₂O in the range of about 1.5 to about 3.5, for example about 2.5 to about 3.2, or about 3.0 to about 3. The ratio represents an average of various molecular weight silicate species. Typical sodium silicate is sodium metasilicate Na₂SiO₃, sodium orthosilicate Na₄SiO₄, and/or sodium pyrosilicate Na₆Si₂O₇.

### Optional Ingredients of the Curable Coating Composition

The composition forming the inorganic binder-based coating is aqueous. Water can be included in any suitable amount, such as from about 10 wt. % to about 70 wt. % by weight of the wet composition, e.g., from about 40 wt. % to about 60 wt. % by weight of the wet (water inclusive) composition.

Optionally, the curable coating composition of the disclosure can further include inorganic solid filler. Generally, any inorganic solid, inert mineral or mineral-like material can be added as an inorganic filler.

The inorganic filler is not the same ingredient as the inorganic binder. Thus, the inorganic filler is substantially free of polyborate salts, alkali metal silicates, and alkaline earth metal silicates. Elsewhere in this disclosure explains the terms, “substantially free of polyborate salts,” “substantially free of alkali metal silicates,” and “substantially free of alkaline earth metal silicates”. However, inorganic fillers comprising glass and clays may include aluminum silicate and/or borosilicate and be within the scope of the disclosure.

Also, the inorganic filler is substantially free of borate salts.

Also, the inorganic filler is substantially free of boric acid.

The solid content of the aqueous coating composition, that is, the aqueous alkali metal polyborate silicate inorganic binder solution and/or dispersion of optional filler in the aqueous alkali metal polyborate silicate inorganic binder solution, can be as high as practical for a particular application up to 75 wt. %, typically up to 65 wt. %, typically 10-60 wt. %, more typically 10-50 wt. %, further typically 20-40 wt. %, based on the total weight of the coating on a dry (water free) basis. For example, clay may be typically 10-30 wt. % of the coating. For example, a typical coating composition may be 20-30 wt. % inorganic binder and 20-30 wt. % clay on a dry basis.

A limiting factor regarding the choice and amount of liquid carrier used is the viscosity obtained with the required amount of solids. Spraying is the most sensitive to viscosity, while other deposition methods are less sensitive. The effective range for the solid content of the coating composition is about 20 wt. % or more, for example, about 25 wt. % or more, about 30 wt. % or more, about 35 wt. % or more, about 40 wt. % or more, or about 45 wt. % or more, based on the total wet (water inclusive) coating composition prior to any drying and/or curing step. That is, the effective range for solid content of the coating composition, as defined herein, includes any aqueous carrier or solvent, such as water, that is typically evaporated from the final, dry coating layer. Alternatively, or in addition, the solid content of the coating composition is about 75 wt. % or less, or about 70 wt. % or less, based on the total coating composition prior to any drying and/or curing step. Thus, the solid content of the coating composition can be bounded by any two of the above endpoints recited for the solid content of the coating composition. For example, the solid content of the coating composition can be from about 35 wt. % to about 75 wt. %.

For example, a coating composition may include 60 wt. % of a 37.5% solids sodium silicate solution, 25 wt. % sodium polyborate, and 15 wt. % additional water, to have a solids content of about 47.5 wt. %, based on the total coating composition prior to any drying and/or curing step. This has 100% inorganic binders (i.e. sodium silicate and sodium polyborate). This has no filler. Thus, when the coating is dried and/or cured, the coating is about 100 wt. % inorganic binder, based on the total weight of the dry coating.

In a further example, a coating composition may include 60 wt. % of a 37.5% solids sodium silicate solution, 20 wt. % sodium polyborate, 5 wt. % kaolin clay, 5 wt. % calcium carbonate (as an inorganic filler), and 10 wt. % additional water, to have a solids content of about 52.5 wt. %, based on the total coating composition prior to any drying and/or curing step. This is has about 42.5 wt. % inorganic binder (i.e. sodium silicate and sodium polyborate) and about 10% inorganic filler (i.e. kaolin clay and calcium carbonate). Thus, when the coating is dried and/or cured, the coating is about 81 wt. % inorganic binder and about 19 wt. % inorganic filler, based on the total weight of the dry coating.

Suitable mineral and mineral-like fillers include, for example, clay (e.g. kaolin clay or bentonite clay), mica, sand, barium sulfate, silica, talc, magnesia, olivine, dolomite, tremolite, xonolite, vermiculite, gypsum, perlite, limestone (calcite or aragonite), magnesite, wollastonite, zinc oxide, zinc sulfate, hollow beads, bentonite salts, fly ash, bottom ash, coal ash, steel slag, iron slag, limestone slag, zeolite, and combinations thereof. In embodiments, the filler is selected from the group consisting of clay, mica, sand, barium sulfate, silica, talc, magnesia, olivine, dolomite, tremolite, xonolite, vermiculite, gypsum, perlite, limestone (calcite or aragonite), magnesite, wollastonite, zinc oxide, zinc sulfate, hollow beads, bentonite salts, fly ash, bottom ash, coal ash, steel slag, iron slag, limestone slag, zeolite, and combinations thereof. In embodiments, the filler comprises calcium carbonate. In embodiments, the filler includes calcium carbonate and kaolin clay.

The particle size of the inorganic filler is not particularly limited, provided that the particle size does not adversely affect the binding properties of the inorganic binder of the coating. In embodiments, the Dp50 by weight particle size of the inorganic filler can be in a range from about 1 μm to about 200 μm, from about 10 μm to about 100 μm, or from about 25 μm to about 75 μm.

In some embodiments, the composition for forming the inorganic binder-based coating is substantially free of calcite. As used herein, “substantially free” can mean either (i) 0 wt. % based on the weight of the composition, or (ii) an ineffective or (iii) an immaterial amount of calcite. An example of an ineffective amount is an amount below the threshold amount to achieve the intended purpose of using such calcite, as one of ordinary skill in the art will appreciate. An immaterial amount may be, e.g., below about 1 wt. %, below about 0.5 wt. %, below about 0.2 wt. %, below about 0.1 wt. %, or below about 0.01 wt. %.

The coating composition and coating layer can optionally further include one or more components, such as, dispersants, pigments, surfactants, pH modifiers, buffering agents, viscosity modifiers, stabilizers, defoamers, flow modifiers, and combinations thereof.

In embodiments, the coating composition includes one or more dispersants. Suitable dispersants include, for example, tetrapotassium pyrophosphate (TKPP) (FMC Corp.), sodium polycarboxylates such as Tamol® 731A (Rohm & Haas) and nonionic surfactants such as Triton™ CF-10 alkyl aryl polyether (Dow Chemicals). In embodiments, the coating composition includes a dispersant selected from nonionic surfactants such as Triton™ CF-10 alkyl aryl polyether (Dow Chemicals).

Optionally, the coating composition and coating layer may further include minor amounts of a component to impart increased water resistance to the coating. For example, a component to impart increased water resistance can be included in the coating composition and/or coating layer in an amount of about 3 wt. % or less, about 2 wt. % or less, or about 1 wt. % or less. Suitable components that impart increased water resistance include, for example, siloxanes that impart hydrophobicity to the coating. A siloxane is a functional group in organosilicon chemistry with the Si—O—Si linkage. Suitable siloxanes include, but are not limited to, polymethylhydrosiloxane, polydimethylsiloxane, and combinations thereof. There may be an absence of components to impart increased water resistance to the coating.

### Preparation of the Curable Coating Composition

The curable coating composition for the fibrous panel may be prepared by admixing the inorganic binder, and other optional components (e.g. the inorganic filler) using conventional mixing techniques. Typically, the coating particles or solids are suspended in an aqueous carrier. Typically, the inorganic binder(s) including the alkali metal polyborate salt and metal silicate, and, optionally, the inorganic filler are added to and mixed with the aqueous carrier, followed by the other optional components in descending order according to the dry wt. % amount. The coating composition can then be deposited on the fibrous panel or the gypsum wallboard to form the coating layer.

Alternatively, for the fibrous panel the coating layer may be prepared by depositing the inorganic binder and, when present, the inorganic filler step-wise to the fibrous panel. In such embodiments, the inorganic binder is added and mixed with an aqueous carrier, followed by the other optional components as described above, to form a binder dispersion. Similarly, the inorganic filler can be added and mixed with an aqueous carrier, followed by the other optional components as described above, to form a filler dispersion. The binder dispersion and the filler dispersion can then be deposited on the fibrous panel step-wise. For example, in some embodiments, the binder dispersion is deposited on the fibrous panel, followed by the filler dispersion. In another embodiment, the filler dispersion is deposited on the fibrous panel, followed by the binder dispersion.

For the gypsum wallboard, the inorganic binder is added and mixed with an aqueous carrier, followed by the other optional components as described above, to form a binder dispersion that is applied to a surface of the gypsum wallboard.

The inorganic binder coating can be applied to the back cover sheet of the gypsum wallboard in any suitable manner. For example, in some embodiments, it can be rolled or sprayed on the back side of dry board. For example, the coating can be introduced directly on the outside surface of back paper during the board production process. It is also possible to make “sandwich back paper” during the board production process, i.e., the inorganic binder layer is added in between two layers of back paper. The “sandwich back paper” then is used as the single layer of the back paper to make gypsum wallboard. The back paper can be either hydrophilic or hydrophobic. If present, the enhancing layer can be applied over the inorganic binder-based coating (before or after allowing the inorganic based coating to dry). If desired, the enhancing layer can be applied first, with the inorganic binder-based coating applied over the enhancing layer (wet or dry). The inorganic binder-based coating and enhancing layer can have any suitable dimensions. For example, in some embodiments, the inorganic binder-based coating can have a thickness of from about 0.02 inch to about 0.125 inch, such as from about 0.03 inch to about 0.0625 inch. In some embodiments, the enhancing layer can have a thickness of from about 0.018 inch to about 0.0625 inch, e.g., from about 0.02 inch to about 0.06 inch.

Optionally, an enhancing layer can be used as a second layer on the surface of the inorganic binder coating on the building panel, either the gypsum wallboard or the acoustic tile. The enhancing layer can be used in order to improve sag resistance. The enhancing layer comprises enhancing agents that have mild acidic pH (e.g., a pH of from about 0.2 to about 6.5, such as from about 0.2 to about 4, from about 0.5 to about 4 or from about 0.5 to about 3.0), and solid filler additives.

For example, mild acidic materials in aqueous solutions can include calcium chloride, aluminum sulfate, phosphoric acid, aluminum chloride, magnesium chloride, acetate acid, etc., or any combination thereof. The solid filler additives in the enhancing layer can be minerals such as calcite, calcium carbonate, clay, mica, magnesite, perlite, or solid waste such as fly ash, slag, etc., or any combination thereof. The enhancing layer can include either the enhancing agents in an aqueous solution or in a combination of the enhancing agent solution and solid additives.

### Fibrous Panel

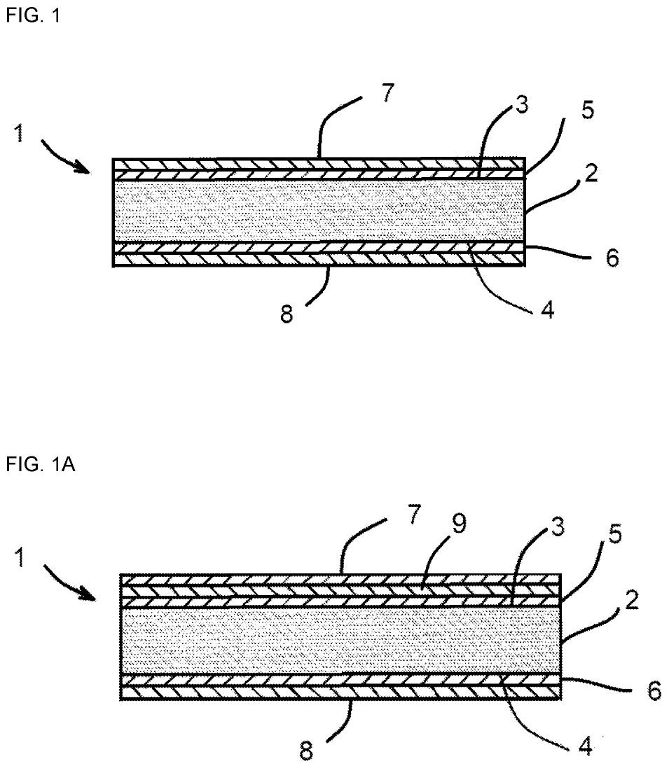

The disclosure is further directed to a fibrous panel (e.g., an acoustical panel, a ceiling tile) coated with the coating composition of the disclosure. A coated fibrous panel 1 in accordance with one aspect of the present disclosure, as illustrated schematically in FIG. 1, comprises a panel core 2 having a backing side 3 and a facing side 4. The panel optionally further comprises a backing layer 5 in contact with the backing side 3, and/or a facing layer 6 in contact with the facing side 4. A back coating layer 7 is disposed on, for example, in direct contact with the backing side 3 or optional backing layer 5 of the panel core 2. Optionally, a further front coating layer 8 is disposed directly on or over the facing side 4 or optional facing layer 6.

The back coating layer 7 beneficially counteracts the sagging force of gravity in humid conditions. The backing side 3 may be the side that is directed to the plenum above the panel in a suspended ceiling tile system. The coated panel 1 may be an acoustical panel for attenuating sound. The backing side 3 may be the side that is directed to a wall behind the panel in applications where an acoustical panel is provided on walls.

An illustrative procedure for producing the panel core 2 is described in U.S. Pat. No. 1,769,519. In one aspect, the panel core 2 comprises a mineral wool fiber and a starch. In another aspect of the present disclosure, the starch component can be a starch gel, which acts as a binder for the mineral wool fiber, as is disclosed in U.S. Pat. Nos. 1,769,519, 3,246,063, and 3,307,651. In a further aspect of the present disclosure, the panel core 2 can comprise a glass fiber panel.

The panel core 2 of the coated panel of the disclosure can also include a variety of other additives and agents. For example, the panel core 2 can include a calcium sulfate material (such as, stucco, gypsum and/or anhydrite), boric acid and sodium hexametaphosphate (SHMP). Kaolin clay and guar gum may be substituted for stucco and boric acid when manufacturing acoustical tile.

The core of the coated panel of the present disclosure can be prepared using a variety of techniques. In one embodiment, the panel core 2 is prepared by a wet- or water-felted process, as is described in U.S. Pat. Nos. 4,911,788 and 6,919,132. In another embodiment, the panel core 2 is prepared by combining and mixing starch and a variety of additives in water to provide a slurry. The slurry is heated to cook the starch and create the starch gel, which is then mixed with mineral wool fiber. This combination of gel, additives, and mineral wool fiber (referred to as “pulp”) is metered into trays in a continuous process. The bottom of the trays into which the pulp is metered can optionally contain a backing layer 5 (for example, a bleached paper, unbleached paper, or kraft paper-backed aluminum foil, hereinafter referred to as kraft/aluminum foil), which serves to aid in the release of the material from the tray, but also remains as part of the finished product. The surface of the pulp can be patterned, and the trays containing the pulp can be subsequently dried, for example, by transporting them through a convection tunnel dryer. Next, the dried product or slab can be fed into a finishing line, where it may be cut to size to provide the panel core 2. The panel core 2 can then be converted to the panel of the present disclosure by application of the coating composition of the disclosure. The coating composition is preferably applied to the panel core 2 after the core has been formed and dried. In yet another embodiment, the panel core 2 is prepared according to the method described in U.S. Pat. No. 7,364,015, which is incorporated by reference herein. Specifically, the panel core 2 comprises an acoustical layer comprising an interlocking matrix of set gypsum, which can be a monolithic layer or can be a multi-layer composite. Desirably, the panel core 2 can be prepared on a conventional gypsum wallboard manufacturing line, wherein a ribbon of acoustical panel precursor is formed by casting a mixture of water, calcined gypsum, foaming agent, and optionally cellulosic fiber (e.g., paper fiber), lightweight aggregate (e.g., expanded polystyrene), binder (e.g., starch, latex), and/or enhancing material (e.g., sodium trimetaphosphate) on a conveyor belt.

In embodiments, the panel core comprises a backing sheet (e.g., paper, metallic foil, or combination thereof), optionally coated with scrim layer (e.g., paper, woven or nonwoven fiberglass) and/or densified layer precursor comprising calcined gypsum and having a density of at least about 35 lbs/ft³. In yet another embodiment, the panel core 2 is prepared according to the wet-felting process. In the wet-felting process, an aqueous slurry of the panel-forming materials including mineral wool, expanded perlite, starch and minor additives, are deposited onto a moving wire screen, such as a Fourdrinier or cylinder former. On the wire screen of a Fourdrinier, a wet mat is formed by dewatering the aqueous slurry by gravity and then optionally by vacuum suction. The wet mat is pressed to a desired thickness between press rolls for additional dewatering. The pressed mat is dried in ovens and then cut to produce acoustical panels. The panel core 2 can then be converted to the panel of the present disclosure by application of the coating composition of the disclosure. The coating composition is preferably applied to the panel core 2 after the core has been formed and dried.

In a further embodiment, the panel core 2 can include, as a preservative, one or more formaldehyde-free biocides.

As previously discussed, the coated panel in accordance with the present disclosure can optionally include the backing layer 5. Numerous materials can be employed as the backing layer 5, including unbleached paper, bleached paper, kraft/aluminum foil, and the like. A flame resistant back coating optionally can be applied in combination with bleached or unbleached paper backing to improve the products surface burning characteristics. The flame resistant back coating can include a variety of components, such as, for example, water, a flame retardant, and a biocide. The backing layer 5 may also be employed for improving sag resistance and/or sound control. In addition, a fill coating or a plurality of fill coatings may also be applied to the backing layer 5. The fill coating can include a variety of components, such as, for example, water, fillers, binders, and various other additives, such as defoamers, biocides, and dispersants. Generally, when a fill coating is used, the fill coating typically is applied after the metal silicate coating of the disclosure.

The coating composition of the present disclosure is suitable for use in coating 7 and/or coating 8 on the facing side 4 and/or the backing side 3 of the panel 1 such as a fibrous panel (e.g., an acoustical panel or ceiling tile). Typically the coating composition of the present disclosure comprising alkali metal polyborate silicate inorganic binder is suitable for use in coating 7 on the backing side 3 of the panel 1.

FIG. 1A schematically illustrates a perspective view of a coated acoustical panel according to a second embodiment of the disclosure that is the embodiment of FIG. 1 modified to additionally have an intermediate alkali metal silicate coating 9 between the core 2 and the coating 7 comprising alkali metal polyborate silicate inorganic binder on the backing side 3 of the panel 1. In addition, or in the alternative, an intermediate alkali metal silicate coating (not shown) may be between the core 2 and the coating 9 comprising alkali metal polyborate silicate inorganic binder on the facing side 4 of the panel 1.

The coating composition of the disclosure can be used with acoustical panels known in the art and prepared by methods known in the art, including acoustical panels prepared by a water-felting method. For example, acoustical panels and the preparation thereof are described in, for example, U.S. Pat. Nos. 1,769,519, 3,246,063, 3,307,651, 4,911,788, 6,443,258, 6,919,132, and 7,364,015, each of which are incorporated herein by reference. Suitable commercial ceiling tiles for use in accordance with the present disclosure include, for example, Radar™ brand ceiling tiles available from USG Interiors, Inc. of Chicago, Ill. The Radar™ brand tile is a water-felted slag wool or mineral wool fiber panel having a ⅝″ thickness and the following composition: 1-75 wt. % slag wool fiber, 5-75 wt. % expanded perlite, 1-25 wt. % cellulose, 5-15 wt. % starch, 0-15 wt. % kaolin, 0-80 wt. % calcium sulfate dehydrate, less than 2 wt. % limestone or dolomite, less than 5 wt. % crystalline silica, and less than 2 wt. % vinyl acetate polymer or ethylene vinyl acetate polymer. The diameters of the mineral wool fibers vary over a substantial range, e.g., 0.25 to 20 microns, and most of the fibers are in the range of 3 to 4 microns in diameter. The lengths of the mineral fibers range from about 1 mm to about 8 mm.

### Methods of Coating a Building Panel

The disclosure provides a method of making a coated building panel comprising:
providing the building panel comprising a backing side and an opposing facing side, and
depositing a first coating layer of an aqueous coating composition comprising an inorganic alkali metal polyborate silicate binder dissolved in water on at least one side of the building panel, the inorganic alkali metal polyborate silicate binder comprising a mixture of an inorganic alkali metal polyborate and an inorganic alkali metal silicate,
curing the coating layer of the aqueous coating composition comprising the inorganic alkali metal polyborate silicate binder to form a cured coating layer comprising the inorganic alkali metal polyborate silicate binder;
the cured coating layer comprising about 25 to 100 wt. %, preferably 30-100 wt. %, more preferably 30-80 wt. %, alkali metal polyborate silicate inorganic binder, based on the total dry weight of the cured coating.

The building panel may be a fibrous panel, such as acoustic ceiling tile or other fibrous panel, or may be a gypsum wallboard. The coating is deposited on the backing side of the building panel to provide a back coating. As used herein, “back coating” refers to a alkali metal polyborate silicate coating provided on the backing side of the building panel.

The coated fibrous panel may include one coating layer comprising an alkali metal polyborate silicate inorganic binder according to the disclosure. In embodiments, the coated fibrous panel includes at least 1, 2, 3, or 4 coating layers up to 8, 9, or 10 coating layers, for example, 1, 2, 3, 4, 5, 6, 7, 8, 9, or 10 coating layers comprising an inorganic binder according to the disclosure. Each coating layer of the disclosure includes the inorganic binder of the present invention, wherein each cured coating layer comprises about 25 to 100 wt. %, preferably 30-100 wt. %, more preferably 30-80 wt. %, alkali metal polyborate silicate inorganic binder, based on the total dry weight of the cured coating.

In embodiments wherein at least a second coating layer is applied to the fibrous panel, the method of coating further includes depositing the second coating layer including the inorganic binder of the present invention in contact with or over the first coating layer including the inorganic binder of the present invention.

In embodiments wherein more than two coating layers are applied, the subsequent coating layer can be provided such that it is in contact with or over the previously deposited coating layer. That is, for example, a third coating layer can be in contact with the second coating layer.

In embodiments, the first and/or second coating layer(s), and any subsequent coating layer deposited thereon (e.g. the third, fourth, fifth, sixth, seventh, eighth, ninth, and/or tenth coating layers), can optionally further include an inorganic filler, wherein the inorganic filler is present in an amount up to about 75 wt. %, typically up to 65 wt. %, based on the weight of the dry coating layer. The inorganic binder and inorganic filler are not the same ingredient.

In embodiments wherein the inorganic filler is present in the coating layer, the method of the disclosure can further include mixing the inorganic binder and the inorganic filler to form a curable coating composition prior to depositing the coating layer. That is, the inorganic binder and the inorganic filler, when present, can be pre-mixed, and therefore, deposited concurrently in a mixture. In other embodiments wherein the inorganic filler is present in the coating layer, the inorganic filler and inorganic binder are deposited step-wise from an inorganic binder dispersion and an inorganic filler dispersion. Optionally, the inorganic filler is deposited first and the inorganic binder is deposited subsequently and in contact with the first, inorganic filler layer. In embodiments, a dispersant may be mixed into the curable coating composition and deposited concurrently with the inorganic binder and inorganic filler. A dispersant may also be included in the inorganic binder dispersion and/or inorganic filler dispersion when the binder and filler are deposited step-wise.

The coating composition can be applied to one or more surfaces of a panel, preferably a fibrous acoustical panel or ceiling tile substrate, using a variety of techniques readily known to and available to those skilled in the art. Such techniques include, for example, airless spraying systems, air assisted spraying systems, and the like. The coating may be applied by such methods as roll coating, flow coating, flood coating, spraying, curtain coating, extrusion, knife coating and combinations thereof. The polyborate salt and metal silicate coating may be applied to have a coat weight in an amount on wet basis of from about 10 g/ft² to about 40 g/ft² (about 108 g/m² to about 430 g/m²), from about 15 g/ft² to about 35 g/ft² (about 161 g/m² to about 377 g/m²), and from 15 g/ft² to about 25 g/ft² (about 161 g/m² to about 269 g/m²). The aqueous coating composition may have any suitable solids content, for example, in a range of about 15 wt. % to about 80 wt. %, from about 35 wt. % to about 80 wt. %, from about 45 wt. % to about 75 wt. %, or from about 45 wt. % to about 70 wt. %. For example, applying about 108 g/m² to about 430 g/m² of a 65 wt. % solids coating on a wet (water inclusive) basis may result in a coat weight on a dry (water free) basis of about 70 g/m² to about 280 g/m². In an embodiment, the coating composition of the disclosure is applied to the backing side 30 of the panel. In another embodiment, the coating composition of the disclosure is applied to the backing layer 35 of the panel.

After the curable coating composition of the disclosure has been applied to the panel either as a premixed curable composition or by step-wise deposition of the inorganic binder and the optional inorganic filler, the coated fibrous panel can be dried or cured. As used herein, “curing” refers to any chemical or morphological change that is sufficient to alter the properties of the binder, such as, for example, via covalent chemical reaction (e.g., condensation reaction), hydrogen bonding, and the like. The coated fibrous panel can be dried after each individual coating layer is applied (e.g., after a single deposition of a pre-mixed composition of the inorganic binder and the inorganic filler), or after all coating layers have been applied (e.g., after multiple depositions of a pre-mixed composition of the inorganic binder and the inorganic filler, or after step-wise addition of compositions containing the inorganic binder or the inorganic filler). Drying the fibrous panel assists in the formation of a crosslinked/dehydrated solid polyborate salt and metal silicate coating layer. In embodiments, the coated fibrous panel is dried by air drying. That is, the fibrous panel is allowed to dry under ambient, room temperature conditions without the application of heat or forced air. Alternatively, or in addition, in embodiments, the composition can be dried by heating the coated fibrous panel. Without intending to be bound by theory, heating is believed to effect curing and crosslinking/dehydration of the inorganic polyborate and silicate binder thereby strengthening the borate and silicate structural matrix. Further, when an inorganic filler is present, heating is believed to enhance retention of the inorganic filler within the polyborate and silicate structural matrix. Drying the resulting product removes any water used as a carrier for the coating composition or any of the components thereof and converts the inorganic polyborate silicate binder into a structural, rigid network capable of providing enhanced structural rigidity to the panel.

When the coated fibrous panel is dried by heating, the duration and temperature of heating will affect the rate of drying, case of processing or handling, and property development of the heated substrate. Heat treatment at from about 100° C. to about 500° C. (e.g., about 200° C. to about 300° C., or about 300° C. to about 500° C.) for a period of from about 3 seconds to about 15 minutes are suitable for drying the coated fibrous panel(s) of the disclosure. For acoustical panels, suitable temperatures can be in a range of from about 300° C. to about 500° C., or about 350° C. to about 450° C. (about 600 to about 800° F.). Generally, heating is conducted until a coating surface temperature of about 200° C. or 240° C. (about 390 to about 465° F.) is achieved, as this is indicative of a full cure. In embodiments, the method includes further heating the coated fibrous panel to a surface temperature of at least 300° F. (150° C.), at least 400° F. (205° C.), or at least 450° F. (about 230° C.).

The drying and curing functions can be effected in two or more distinct steps, if desired. For example, the curable coating composition can be first heated at a temperature, and for a time, sufficient to substantially dry, but not to substantially cure the composition, and then heated for a second time, at a higher temperature, and/or for a longer period of time, to effect full curing. Such a procedure, referred to as “B-staging,” can be used to provide coated panels in accordance with the disclosure.

In embodiments, the method further includes depositing a chemical curing layer. The methods of the disclosure can utilize chemical curing in addition to or even in lieu of drying and/or heat curing. Chemical curing may include depositing a multivalent metal compound or an acidic solution to form cured polyborate salt and metal silicate coatings by precipitation of insoluble metal silicate compounds from solution to provide a solid layer. In embodiments, the coating layer(s) may be further coated with a solution of a multivalent metal or acid. In embodiments wherein the inorganic binder and optional inorganic filler are deposited step-wise, the multivalent metal or acid may be provided with the inorganic filler and/or the inorganic binder and deposited concurrently therewith. In embodiments wherein multiple pre-mixed coating layers are applied, a chemical curing layer can be applied between each coating layer.

Without intending to be bound by theory, it is believed that the multivalent metal displaces any monovalent cations (e.g., sodium, lithium, or potassium) in the interstitial spaces of the inorganic network accelerating curing and forming an insoluble silicate coating. The multivalent metal can be provided as a bivalent and/or trivalent metal salt. Suitable multivalent metals include, but are not limited to, Be²⁺, Mg²⁺, Ca²⁺, Sr²⁺, Ba²⁺, Zn²⁺, Cu²⁺, Fe²⁺, Fe²⁺, and Al²⁺. In embodiments, the multivalent metal includes a metal salt having a cation selected from the group consisting of beryllium, magnesium, calcium, strontium, barium, zinc, copper, iron, aluminum, and combinations thereof. In embodiments, the multivalent metal includes a metal salt having a cation selected from the group consisting of calcium, magnesium, zinc, copper, iron, aluminum, and combinations thereof. In embodiments, the multivalent metal includes an alkaline earth metal salt having a cation selected from the group consisting of beryllium, magnesium, calcium, strontium, barium, and combinations thereof. Suitable salts include borates, chlorides, carbonates, sulfates, and combinations thereof. In embodiments, the multivalent metal is provided in the form of an oxide, hydroxide or combinations thereof. Without intending to be bound by theory, it is believed that slower dissolving compounds, for example carbonate salts, oxides, hydroxides, and the like may be used to provide stable formulations.

In embodiments wherein an acid is used for chemical curing, the acid may be any acid, for example an organic acid or a mineral acid including but not limited to organic acids and mineral acids selected from the group consisting of acetic acid, sulphuric acid, phosphoric acid, and combinations thereof.

In embodiments, the multivalent metal compound or acid can be present in the composition for forming the chemical curing layer in any suitable amount for enhancing curing of the coating layer(s), for example, in an amount ranging from about 5 wt. % to about 30 wt. %, about 10 wt. % to about 25 wt. %, or about 15 wt. % to about 20 wt. %, based on the weight of the composition for forming the chemical curing layer (prior to any drying and/or curing step).

In embodiments, the composition for chemical curing can further include an inorganic filler. Suitable inorganic fillers include those that may be included in the coating layers, such as, for example, clay (e.g. kaolin clay or bentonite clay), mica, sand, barium sulfate, silica, talc, magnesia, olivine, dolomite, tremolite, xonolite, vermiculite, gypsum, perlite, limestone (calcite or aragonite), magnesite, wollastonite, zinc oxide, zinc sulfate, hollow beads, bentonite salts, fly ash, bottom ash, coal ash, steel slag, iron slag, limestone slag, zeolite, and combinations thereof.

In embodiments, the inorganic filler can be present in the composition for forming the chemical curing layer in an amount ranging up to about 50 wt. %, about 5 wt. % to about 45 wt. %, about 10 wt. % to about 40 wt. %, about 15 wt. % to about 25 wt. %, based on the weight of the composition for forming the chemical curing layer (prior to any drying and/or curing step).

In embodiments, the chemical curing layer includes calcium chloride and an inorganic filler, such as clay.

The multivalent metal compound-containing curing composition can be applied by any technique known in the art, for example, airless spraying systems, air assisted spraying systems, and the like. The multivalent metal compound coating may be applied by such methods as roll coating, flow coating, flood coating, spraying, curtain coating, extrusion, knife coating and combinations thereof. Solutions of multivalent metal compounds, including but not limited to calcium chloride, magnesium chloride, and combinations thereof, can be sprayed onto a hot panel coated with the curable coating composition. Without intending to be bound by theory, it is believed that there is a minimum amount of multivalent metal salt required to drive the chemical curing reaction to completion. Suitable coat weights of multivalent metal salts for driving the chemical curing reaction to completion are at least about 2.5 mmol/ft², or at least about 5 mmol/ft² on a wet or dry basis. The multivalent metal may be deposited as a salt, at a coat weight (on a dry or wet basis) in the range of about 2.5 mmol/ft² to about 35 mmol/ft², or about 5 mmol/ft² to about 30 mmol/ft².

Optionally, after the solution of a multivalent metal compound is sprayed onto the panel, the panel can be dried and heated again, for example, to a temperature in a range of 100° F. to 600° F. (about 35° C. to about 315° C.), or about 300° F. to about 400° F. (about 150° C. to about 205° C.), for 20 seconds to five minutes. Alternatively, or in combination with heating, after the solution of a multivalent metal compound is sprayed onto the panel, the panel can be dried by air drying.

The coated panel of the disclosure has increased resistance to permanent deformation (sag resistance), as determined according to ASTM C367M-09.

### Gypsum Board

A gypsum slurry (sometimes called a stucco slurry) is used to prepare one or more gypsum layers in the composite board. Normally, the composite board contains a primary gypsum layer, often referred to as a core, located between the face and back cover sheets. In some embodiments, a skim coat is disposed between the core and one or both cover sheets. In some embodiments, a concentrated layer (as described in U.S. Patent Application Publication Nos. US 2016/0375655 A1, US 2016/0375656 A1, US 2016/0375651 A1, and US 2016/0376191 A1) is provided between the so-called gypsum core and one or both of the cover sheets. The gypsum slurry includes water and stucco, as well as other optional ingredients as desired.

Typically the gypsum board core comprises a less dense region (layer) and further comprise a high-density region (layer) in contact with the inner surface of the front paper cover sheet.

For purposes of this description, the word high in the term high-density region means having a density higher than the density of the low-density region. The word low in the term low-density region means having a density lower than the density of the high-density region. Typically the high-density region is not foamed. Typically the low-density region is foamed. This description also refers to the high-density region as a densified layer or a thin dense layer.

In particular the invention provides a gypsum board comprising:
a board core layer comprising set gypsum,
a front paper cover sheet having an outer surface and an inner surface, the inner surface contacting a first face of the board core; and
a back paper cover sheet having an outer surface and an inner surface, the inner surface facing a second face of the board core;
a cured coating composition on an outer surface of at least one of the front cover sheet or the back cover sheet, the cured coating layer comprising about 25 to 100 wt. %, preferably 30-100 wt. %, more preferably 30-80 wt. %, alkali metal polyborate silicate inorganic binder, based on the total dry weight of the cured coating, and optionally a solid filler;
wherein the core layer is between the first cover sheet and the second cover sheet,
wherein the board core layer preferably comprises a low-density region comprising set gypsum and a high-density region comprising set gypsum, the high-density region being interposed as a layer between the low-density region and the front paper cover sheet, the high-density region having a higher density than the low-density region,
wherein there is preferably an absence of a high-density region comprising set gypsum between the low-density region and the back cover sheet.
wherein the core layer resulted from setting, between the front paper cover sheet and the back paper cover sheet, an aqueous slurry comprising a mixture of water and stucco, wherein the stucco comprises calcium sulfate hemihydrate, wherein the aqueous slurry comprises:
   at least 60 weight percent said calcium sulfate hemihydrate on a dry basis, and said water at a weight ratio of water to the calcium sulfate hemihydrate of 0.2:1 to 1.2:1.

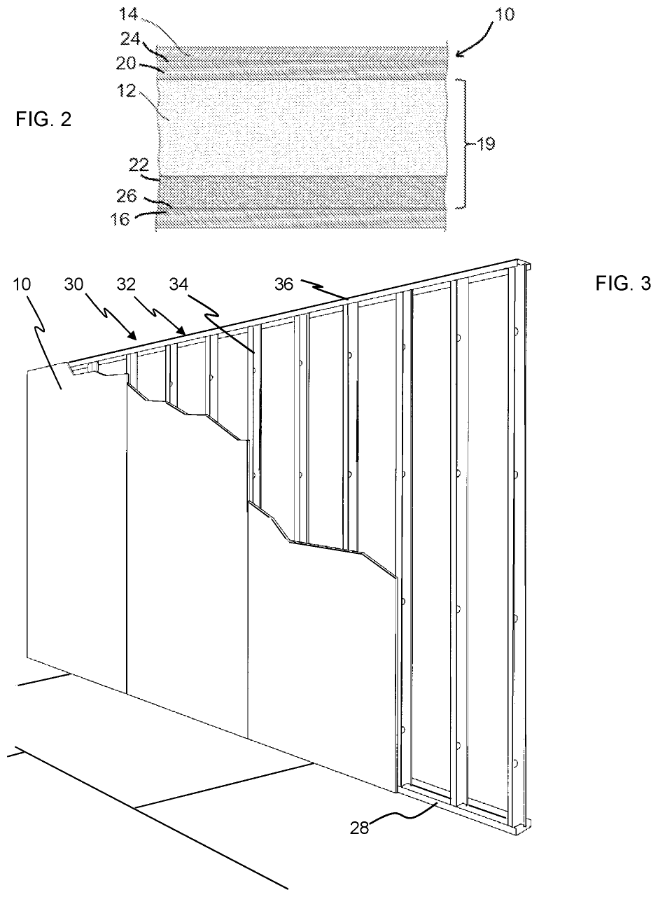

FIG. 2 depicts an example of a gypsum wallboard panel 10 of the invention. The board has a core 19 that comprises a set low-density region (less dense region) 12 as a layer comprising calcium sulfate dihydrate and a set high-density region (thin dense gypsum layer) 22 as a layer comprising calcium sulfate dihydrate.

FIG. 2 depicts the wallboard panel 10 of the invention in which a gypsum low-density region 12 (for example 0.5 inch thick) is sandwiched between a back paper cover sheet 20 (also known as a backer paper cover sheet) and a front paper cover sheet 16 (also known as a facer paper cover sheet), which may each be single-ply or multi-ply paper. The inner surface of the back paper cover sheet 20 creates a surface side 24 of the back paper cover sheet 20 which faces away from the gypsum core. The inner surface of the front paper cover sheet 16 creates a bond side 26 of the front paper cover sheet 16 which faces the gypsum low-density region 12. The outer surface 24 of the back paper cover sheet 20 faces wall framing (not shown) of a room after the wallboard panel 10 is installed as an interior wall. The outer surface of the front paper cover sheet 16 faces inside of a room after the wallboard panel 10 is installed as an interior wall.

An inorganic coating layer 14 comprising the polyborate and silicate lies on the back sheet 20 surface side 24. A high-density region (thin dense gypsum layer) 22 lies between the gypsum low-density region (less dense region) 12 and the front paper cover sheet 16 to contact the gypsum low-density region 12 and the front paper cover sheet 16. Generally the gypsum low-density region 12 and the high-density region 22 have the same composition. However, the low-density region slurry has been foamed and the high-density region slurry has not been foamed so it is denser than the low-density region slurry.

The wallboard panel 10 has no thin dense layer of gypsum between the back paper cover sheet 20 and the gypsum low-density region (less dense region) 12. Optionally, but not show, an inorganic coating layer 14 comprising the polyborate and silicate lies on the facer side of the gypsum core.

The high-density region (thin, dense gypsum layer) 22 is applied to an inner surface of a front paper cover sheet 16. Generally the relatively low-density region 12 and relatively high-density region 22 have the same composition and are contiguous with one another. However, the low-density region may be formed from a gypsum slurry in a foamed state, whereas the high-density region may be in formed from a gypsum slurry that is not foamed so that a denser layer forms. That is, the high-density region may have a lower porosity associated therewith than does the low-density region.

### Back Fibrous Cover Sheet and the Front Fibrous Cover Sheet

It will be understood that, with respect to cover sheets of the gypsum board, the terms “face”, “facer”, “top” and “front” cover sheets are used interchangeably herein, while the terms “backer”, “bottom” and “back” cover sheets are likewise used interchangeably herein.

For example, the cover sheets of the gypsum board may comprise cellulosic fibers, glass fibers, ceramic fibers, mineral wool, or a combination of the aforementioned materials. The back and front cover sheets are preferably made of paper. Preferably, the back paper cover sheet and the front paper cover sheet may be made from any suitable paper material having any suitable basis weight.

However, the paper materials for each cover sheet may be the same or different.

Various paper grades can be used in gypsum panels, including Manila grade paper with a smooth calendared finish that is often used as the facer paper cover sheet, and Newsline paper with a rougher finish that is often used as the backer paper cover sheet. Typically both paper grades are multi-ply with at least one liner ply and several filler plies. However, if desired at least one paper cover sheet or both paper cover sheets are made of single-ply paper.

Typically a back cover sheet only covers the back surface. In contrast, a front cover sheet covers the front surface of the board and also wraps around the board edges to contact the back cover sheet.

In some embodiments, one or both sheets can comprise glass fibers, ceramic fibers, mineral wool fibers, or a combination of the aforementioned materials. In other embodiments, the cover sheet can be “substantially free” of glass fibers ceramic fibers, mineral wool fibers, or a mixture thereof, which means that the cover sheets contain either (i) 0 wt. % based on the weight of the sheet, or no such glass fibers ceramic fibers, mineral wool fibers, or a mixture thereof, or (ii) an ineffective or (iii) an immaterial amount of glass fibers ceramic fibers, mineral wool fibers, or a mixture thereof. An example of an ineffective amount is an amount below the threshold amount to achieve the intended purpose of using glass fibers ceramic fibers, mineral wool, or a mixture thereof, as one of ordinary skill in the art will appreciate. An immaterial amount may be, e.g., below about 5 wt. %, such as below about 2 wt. %, below about 1 wt. %, below about 0.5 wt. %, below about 0.2 wt. %, below about 0.1 wt. %, or below about 0.01 wt. % based on the weight of stucco as one of ordinary skill in the art will appreciate. However, if desired in alternative embodiments, such ingredients can be included in the cover sheets.

The cover sheets can also have any suitable total thickness. In some embodiments, at least one of the cover sheets has a relatively high thickness, e.g., a thickness of at least about 0.014 inches. Any suitable upper limit for these ranges can be adopted, e.g., an upper end of the range of about 0.030 inches. The total sheet thickness refers to the sum of the thickness of each sheet attached to the gypsum board.

The cover sheets can have any suitable density. For example, in some embodiments, at least one or both of the cover sheets has a density of at least about 36 pcf, e.g., from about 36 pcf to about 46 pcf.

### Gypsum Board Properties

Board weight is a function of the thickness of the board. Boards are commonly made at varying thicknesses. Thus, board density is used herein as a measure of board weight. Examples of suitable nominal thickness include about ¼ inch, about ⅜ inch, about ½ inch, about ⅝ inch, about ¾ inch, or about one inch, and any range using any of the foregoing as endpoints. In some markets, the board can be formed at a nominal thickness according to metric measurements, e.g., about 9 mm, about 10 mm, about 12.5 mm, about 15 mm, about 25 mm, and any range using any of the foregoing as endpoints. Properties referenced herein can be seen in board formed at one or more of the previously mentioned board thicknesses according to various embodiments. The advantages of the gypsum board in accordance with embodiments of the disclosure can be seen at a range of densities, including up to heavier board densities, e.g., about 43 pcf or less, or 40 pcf or less, such as from about 17 pcf to about 43 pcf, from about 27 pcf to about 35 pcf, etc.

The board can have any desired thickness, such as from about 0.25 inch to about one inch (e.g., about 0.25 inch, about 0.375 inch, about 0.5 inch, about 0.625 inch, about 0.75 inch, about one inch, etc.). Desirably, the board has good strength as described herein, such as an average gypsum layer hardness of at least about 11 pounds (5 kg), e.g., at least about 13 pounds (5.9 kg), or at least about 15 pounds (6.8 kg).

### Methods for Manufacture of a Gypsum Board

Various methods can be employed for preparing a gypsum board of the present invention from an aqueous gypsum slurry.

The base material from which gypsum wallboard and other gypsum products are manufactured is the hemihydrate form of calcium sulfate (CaSO₄·½H₂O), commonly termed “calcined gypsum” or “stucco,” which is produced by heat conversion (calcination) of the dihydrate form of calcium sulfate (CaSO₄).

Product according to embodiments of the disclosure can be made on typical manufacturing lines. For example, board manufacturing techniques are described in, for example, U.S. Pat. No. 7,364,676 and U.S. Patent Application Publication 2010/0247937. Briefly, in the case of gypsum board, the process typically involves discharging a cover sheet onto a moving conveyor. Since gypsum board is normally formed “face down,” this cover sheet is the “face” cover sheet in such embodiments.

Dry and/or wet components of the gypsum slurry are fed to a mixer (e.g., pin mixer or pin-less mixer), where they are agitated to form the gypsum slurry. The mixer comprises a main body and a discharge conduit (e.g., a gate-canister-boot arrangement as known in the art, or an arrangement as described in U.S. Pat. Nos. 6,494,609 and 6,874,930). In some embodiments, the discharge conduit can include a slurry distributor with either a single feed inlet or multiple feed inlets, such as those described in U.S. Patent Application Publication 2012/0168527 A1 and U.S. Patent Application Publication 2012/0170403 A1, for example. In those embodiments, using a slurry distributor with multiple feed inlets, the discharge conduit can include a suitable flow splitter, such as those described in U.S. Patent Application Publication 2012/0170403 A1. Foaming agent can be added in the discharge conduit of the mixer (e.g., in the gate as described, for example, in U.S. Pat. Nos. 5,683,635 and 6,494,609) or in the main body if desired. Slurry discharged from the discharge conduit after all ingredients have been added, including foaming agent, is the primary gypsum slurry and will form the board core. This board core slurry is discharged onto the moving face cover sheet.

The face fibrous cover sheet may bear a thin skim coat on its inner surface in the form of a relatively dense layer of gypsum slurry. Also, hard edges, as known in the art, can be formed, e.g., from the same slurry stream forming the face skim coat. In embodiments where foam is inserted into the discharge conduit, a stream of secondary gypsum slurry can be removed from the mixer body to form the dense skim coat slurry, which can then be used to form the face skim coat and hard edges as known in the art. If included, normally the face skim coat and hard edges are deposited onto the moving face cover sheet before the core slurry is deposited, usually upstream of the mixer. After being discharged from the discharge conduit, the core slurry is spread, as necessary, over the face cover sheet (optionally bearing skim coat) and covered with a second fibrous cover sheet (typically the “back” cover sheet) to form a wet assembly in the form of a sandwich structure that is a board precursor to the final product. The second cover sheet may optionally bear a second skim coat on its inner surface, which can be formed from the same or different secondary (dense) gypsum slurry as for the face skim coat, if present. The fibrous cover sheets may be formed from paper, fibrous mat or other type of material (e.g., foil, plastic, glass mat, non-woven material such as blend of cellulosic and inorganic filler, etc.).

The wet assembly thereby provided is conveyed to a forming station where the product is sized to a desired thickness (e.g., via forming plate), and to one or more knife sections where it is cut to a desired length. The wet assembly is allowed to harden to form the interlocking crystalline matrix of set gypsum, and excess water is removed using a drying process (e.g., by transporting the assembly through a kiln).

It also is common in the manufacture of gypsum board to use vibration in order to eliminate large voids or air pockets from the deposited slurry. Each of the above steps, as well as processes and equipment for performing such steps, are known in the art.

In some embodiments, the gypsum board can be formed to have the gypsum layer in the form of a concentrated layer on one or both sides of a core layer in a bonding relation, as described in commonly-assigned U.S. Pat. No. 10,421,250 to Li et al.; U.S. Pat. No. 11,040,513 to Li et al.; U.S. Pat. No. 10,421,251 to Li et al.; and US Published Patent Application No. 2016/0376191 to Li et al., which are incorporated by reference.

The invention provides a method of coating a gypsum board, the gypsum board having a gypsum core and a backing side comprising a back fibrous cover sheet and an opposed facing side comprising a front fibrous cover sheet, wherein the gypsum core is between the front fibrous cover sheet and the back fibrous cover sheet, comprising:
applying a first coating layer of an aqueous coating composition comprising an inorganic alkali metal polyborate silicate binder dissolved in water on at least one side of the gypsum board, the inorganic alkali metal polyborate silicate binder comprising a mixture of an inorganic alkali metal polyborate and an inorganic alkali metal silicate, and optionally a solid filler,
curing the coating layer of the aqueous coating composition comprising the inorganic alkali metal polyborate silicate binder to form a cured coating layer comprising the inorganic alkali metal polyborate silicate binder,
the cured coating layer comprising about 25 to 100 wt. %, preferably 30-100 wt. %, more preferably 30-80 wt. %, alkali metal polyborate silicate inorganic binder, based on the total dry weight of the cured coating.

Typically the gypsum board to which the coating is applied was made by a method comprising:
preparing an aqueous gypsum slurry comprising a mixture of water and stucco, wherein the stucco comprises calcium sulfate hemihydrate, wherein the aqueous slurry comprises a mixture of:
   at least 60 wt. %, preferably at least 70 wt. %, more preferably at least 80 wt. %, typically at least 90 wt. % or typically at least 95 wt. % said calcium sulfate hemihydrate on a dry (water free) basis, and
   the water at a weight ratio of water to the calcium sulfate hemihydrate of 0.2:1 to 1.2:1; and
depositing a front fibrous cover sheet, preferably a paper cover sheet,
depositing the aqueous gypsum slurry over the front fibrous cover sheet to form a layer of the aqueous gypsum slurry, wherein a side of the layer of aqueous gypsum slurry faces an inner surface of the front fibrous cover sheet,
then depositing the back fibrous cover sheet, preferably a back paper cover sheet, over the aqueous gypsum slurry, wherein the aqueous gypsum slurry contacts the back fibrous cover sheet;
wherein a first portion of the gypsum slurry is disposed in an unfoamed state as a high-density region in layer form contacting the front fibrous cover sheet and a second portion of the gypsum slurry is disposed in a foamed state as a low-density region contacting the high-density region, the high-density region having a higher density than the low-density region,
setting the calcium sulfate hemihydrate to form a panel comprising a gypsum core comprising calcium sulfate dihydrate, wherein the board core comprises a set low-density region comprising calcium sulfate dihydrate and a set high-density region comprising calcium sulfate dihydrate, the set high-density region being interposed as a layer between the set low-density region and the front fibrous cover sheet,
wherein there is an absence of a high-density region comprising calcium sulfate dihydrate between the low-density region and the back cover sheet; and
drying the panel and cutting the panel into a gypsum board.

Typically, the aqueous gypsum slurry dry (water free) components used for gypsum boards of the invention, and as a result the gypsum board core, has less than 10 wt. %, more typically an absence of, Portland cement or other hydraulic cement or any combination thereof. Typically, the aqueous slurry dry (water free) components, and as a result the gypsum board core has less than 10 wt. %, more typically an absence, of fly ash. Typically, the aqueous slurry dry (water free) components, and as a result the gypsum board core has less than 10 wt. %, more typically an absence, of calcium carbonate.

The low-density region (e.g., low-density region 12 of FIG. 2) resulting from the set gypsum low-density region slurry generally has a thickness of 0.25 inches to 1.5 inches and a density of 15 to 55 pounds/cubic foot. In contrast, generally the high-density region (e.g., high-density region 22 of FIG. 2) has a thickness of 5% to 25% of the thickness of the gypsum board 10. Typically the densified layer has a thickness of from about 0.02 inches to about 0.2 inches (about 0.05 to about 0.5 cm), for example, from about 0.0625 inch to about 0.125 inch (about 0.16 to about 0.32 cm). The thickness of the low-density region layer 12 is greater than the thickness of the high-density region layer 22. When foamed, the gypsum low-density region layer resulting from the set foamed gypsum slurry has a total void volume of 10 to 92 volume percent, particularly 25 to 90 volume percent, and more particularly 30 to 85 volume percent. In contrast, the densified layer has a total void volume of less than 30 volume percent and is less than 0.25 inches thick.

### Gypsum and Stucco (Calcined Gypsum)

The calcium sulfate hemihydrate component used to form the crystalline matrix of the gypsum panel core typically comprises beta calcium sulfate hemihydrate, water-soluble calcium sulfate anhydrite, alpha calcium sulfate hemihydrate, or mixtures of any or all of these, and obtained from natural or synthetic sources. The calcium sulfate hemihydrate is typically provided in the raw material known as stucco or calcined gypsum. In some aspects, the stucco may include non-gypsum minerals, such as minor amounts of clays or other components that are associated with the gypsum source or are added during the calcination, processing and/or delivery of the stucco to the mixer. The stucco can be fibrous or non-fibrous. Any suitable type of stucco can be used in the gypsum slurry, including calcium sulfate alpha hemihydrate, calcium sulfate beta hemihydrate, and calcium sulfate anhydrate. The stucco can be fibrous or non-fibrous.

Typically the raw stucco has at least 70 wt. % calcium sulfate hemihydrate, preferably at least 80 wt. % calcium sulfate hemihydrate, more preferably at least 85 wt. % calcium sulfate hemihydrate, furthermore preferably at least 90 wt. % calcium sulfate hemihydrate, and most preferably at least 95 weight % calcium sulfate hemihydrate.

The calcium sulfate hemihydrate is present in the deposited aqueous slurry for a gypsum wallboard of the invention in amounts of at least 60 weight % of the dry (water free) materials of the aqueous slurry. Preferably the calcium sulfate hemihydrate is at least 70 weight percent of the dry (water free) materials of the aqueous slurry, more preferably at least 80 weight % of the dry (water free) materials of the aqueous slurry, furthermore preferably at least 90 weight % of the dry (water free) materials of the aqueous slurry. In typical wallboard formulations of the invention the dry (water free) materials of the aqueous slurry has at least 90 weight percent or at least 95 weight % calcium sulfate hemihydrate. Use of calcium sulfate anhydrite is also contemplated, although it is preferably used in small amounts of less than 20 weight % of the dry (water free) materials of the aqueous slurry.

Likewise, calcium sulfate dihydrate is present in the board core layer of the gypsum board of the invention and results from setting the aqueous slurry. The calcium sulfate dihydrate is at least 60 wt. % of the board core layer, preferably at least 70 wt. %, and more preferably at least 80 wt. %. Typical wallboard board core layers have at least 90 wt. % or at least 95 wt. % calcium sulfate dihydrate.

### Water

Water is added to the slurry in any amount that makes a flowable gypsum slurry. The amount of water to be used varies greatly according to the application with which it is being used, the exact dispersant being used, the properties of the calcium sulfate hemihydrate, and the additives being used.

Water used to make the slurry should be as pure as practical for best control of the properties of both the slurry and the set plaster. Salts and organic compounds are well known to modify the set time of the slurry, varying widely from accelerators to set inhibitors. Some impurities lead to irregularities in the structure as the interlocking matrix of dihydrate crystals forms, reducing the strength of the set product. Product strength and consistency is thus enhanced by the use of water that is as contaminant-free as practical.

The water can be present in the gypsum low-density region slurry and/or the high-density region layer slurry of the present invention at a weight ratio of water to calcium sulfate hemihydrate of about 0.2:1 to about 1.2:1; preferably, about 0.3:1 to about 1.1:1; more preferably, about 0.6:1 to about 1:1; most preferably 0.7:1 to 0.95:1; and typically about 0.85:1.

### Gypsum Slurry Additives

Other additives that may be present in the gypsum slurry used to form the board core may include, but are not limited to, strengthening agents, foam (prepared from a suitable foaming agent), dispersants, phosphate-containing compounds, such as polyphosphates (e.g., sodium trimetaphosphate), starches, retarders, accelerators, recalcination inhibitors, binders, adhesives, secondary dispersing aids, leveling or non-leveling agents, thickeners, bactericides, fungicides, pH adjusters, buffers, colorants, reinforcing materials, fire retardants, water repellants (for example siloxane), fillers, and mixtures thereof.

Additives and other components of the gypsum slurry may be added to the mixer in various ways. For example, various combinations of components may be pre-mixed before entering the mixer, either as one or more dry components and/or as one or more wet components. Singular components may similarly be introduced to the mixer in wet or dry form. If introduced in a wet form, the components may be included in a carrier fluid, such as water, in any suitable concentration.

Fibers can optionally be used in the methods and composition of the present invention. The fibers may include mineral fibers (also known as mineral wool), glass fibers, carbon fibers, and mixtures of such fibers, as well as other comparable fibers providing comparable benefits to the wallboard. For example, glass fibers can be incorporated in the gypsum low-density region slurry and/or the high-density region layer slurry and resulting crystalline core structure. The glass fibers in such aspects may have an average length of about 0.5 to about 0.75 inches and a diameter of about 11 to about 17 microns. In other aspects, such glass fibers may have an average length of about 0.5 to about 0.675 inches and a diameter of about 13 to about 16 microns. In yet other aspects, E-glass fibers are utilized having a softening point above about 800° C. or above at least about 900° C. Mineral wool or carbon fibers such as those known to those of ordinary skill may be used in place of or in combination with glass fibers.

Fibers, when included, can be present in the gypsum low density layer slurry and/or the gypsum high density layer slurry in amounts on a dry basis per 100 pbw of calcium sulfate hemihydrate of about 0.5 to about 10 pbw; preferably about 1 to about 8 pbw; more preferably about 2 to about 7 pbw; and most preferably about 3 to about 6 pbw. There may also be an absence of fibers.

In some embodiments, the gypsum slurry can optionally include one or more phosphate-containing compounds, if desired. Phosphate-containing components can enhance green strength, resistance to permanent deformation (e.g., sag), dimensional stability, and the like. For example, phosphate-containing components useful in some embodiments include water-soluble components and can be in the form of an ion, a salt, or an acid, namely, condensed phosphoric acids, each of which comprises two or more phosphoric acid units; salts or ions of condensed phosphates, each of which comprises two or more phosphate units; and monobasic salts or monovalent ions of orthophosphates as well as water-soluble acyclic polyphosphate salt. Sec, e.g., U.S. Pat. Nos. 6,342,284; 6,632,550; 6,815,049; and 6,822,033.

Phosphate-containing compounds, for example, one or more trimetaphosphate, hexametaphosphate, pyrophosphate, and tripolyphosphate compounds, can be used. Trimetaphosphate compounds can be used, including, for example, sodium trimetaphosphate, potassium trimetaphosphate, lithium trimetaphosphate, and ammonium trimetaphosphate. Sodium trimetaphosphate (STMP) is commonly used, although other phosphates may be suitable, including for example sodium tetrametaphosphate, sodium hexametaphosphate having from about 6 to about 27 repeating phosphate units and having the molecular formula Naₙ₊₂PₙO₃ₙ₊₁ wherein n=6-27, tetrapotassium pyrophosphate having the molecular formula K₄P₂O₇, trisodium dipotassium tripolyphosphate having the molecular formula Na₃K₂P₃O₁₀, sodium tripolyphosphate having the molecular formula Na₅P₃O₁₀, tetrasodium pyrophosphate having the molecular formula Na₄P₂O₇, aluminum trimetaphosphate having the molecular formula Al(PO₃)₃, sodium acid pyrophosphate having the molecular formula Na₂H₂P₂O₇, ammonium polyphosphate having 1000-3000 repeating phosphate units and having the molecular formula (NH₄)ₙ₊₂PₙO₃ₙ₊₁ wherein n=1000-3000, or polyphosphoric acid having two or more repeating phosphoric acid units and having the molecular formula Hₙ₊₂PₙO₃ₙ₊₁ wherein n is two or more.

If included, the phosphate-containing compound can be present in any suitable amount. To illustrate, in some embodiments, the phosphate-containing compound can be present in an amount, for example, from about 0.01% to about 1 by weight of the stucco. There may also be an absence of phosphate-containing compound. There may also be an absence of one or more trimetaphosphate, hexametaphosphate, pyrophosphate, and tripolyphosphate compounds.

The gypsum slurry can include accelerators or retarders as known in the art to adjust the rate of setting if desired. Accelerators can be in various forms (e.g., wet gypsum accelerator, heat resistant accelerator, and climate stabilized accelerator). Sec, e.g., U.S. Pat. Nos. 3,573,947 and 6,409,825. In some embodiments where accelerator and/or retarder are included, the accelerator and/or retarder each can be in the stucco slurry for forming the board core in an amount on a solid basis of, such as, from about 0% to about 10% by weight of the stucco (e.g., about 0.1% to about 10%), such as, for example, from about 0% to about 5% by weight of the stucco (e.g., about 0.1% to about 5%).

Other optional additives can be included in the gypsum slurry to provide desired properties, including green strength, sag resistance, water resistance, mold resistance, fire rating, thermal properties, board strength, etc. Examples of suitable additives include, for example, strength additives such as starch, dispersant, polyphosphate, high expansion particulate, heat sink additive, fibers, siloxane, magnesium oxide, etc., or any combination thereof. The use of the singular term additive herein is used for convenience but will be understood to encompass the plural, i.e., more than one additive in combination, as one of ordinary skill in the art will readily appreciate.

In some embodiments, the gypsum slurry optionally includes a starch that is effective to increase the strength of the gypsum board relative to the strength of the board without the starch (e.g., via increased nail pull resistance). Any suitable strength enhancing starch can be used, including hydroxyalkylated starches such as hydroxyethylated or hydroxypropylated starch, or a combination thereof, or pregelatinized starches, which are generally preferred over acid-modifying migrating starches which generally provide paper-core bond enhancement but not core strength enhancement. Any suitable pregelatinized starch can be included in the enhancing additive, as described in U.S. Patent Application Publications 2014/0113124 A1 and 2015/0010767 A1, including methods of preparation thereof and desired viscosity ranges described therein.

If included, the starch can be present in any suitable amount. In some embodiments, the starch is present in the gypsum slurry in an amount of from about 0% to about 20% by weight of the stucco, e.g., from about 0% to about 15% by weight of stucco, from about 1% to about 3% by weight of stucco, from about 1% to about 2% by weight of stucco, etc.

Any suitable foaming agent composition useful for generating foam in gypsum slurries can be utilized. Suitable foaming agents are selected to result in air voids in the final product such that the weight of the board core can be reduced. In some embodiments, the foaming agent comprises a stable soap, an unstable soap, or a combination of stable and unstable soaps. In some embodiments, one component of the foaming agent is a stable soap, and the other component is a combination of a stable soap and unstable soap. In some embodiments, the foaming agent comprises an alkyl sulfate surfactant. There may also be an absence of foaming agents.

Some types of unstable soaps, in accordance with embodiments of the disclosure, are alkyl sulfate surfactants with varying chain length and varying cations. Suitable chain lengths, can be, for example, C8-C12, e.g., C8-C10, or C10-C12. Suitable cations include, for example, sodium, ammonium, magnesium, or potassium. Examples of unstable soaps include, for example, sodium dodecyl sulfate, magnesium dodecyl sulfate, sodium decyl sulfate, ammonium dodecyl sulfate, potassium dodecyl sulfate, potassium decyl sulfate, sodium octyl sulfate, magnesium decyl sulfate, ammonium decyl sulfate, blends thereof, and any combination thereof.

Some types of stable soaps, in accordance with embodiments of the disclosure, are alkoxylated (e.g., ethoxylated) alkyl sulfate surfactants with varying (generally longer) chain length and varying cations. Suitable chain lengths, can be, for example, C10-C14, e.g., C12-C14, or C10-C12. Suitable cations include, for example, sodium, ammonium, magnesium, or potassium. Examples of stable soaps include, for example, sodium laureth sulfate, potassium laureth sulfate, magnesium laureth sulfate, ammonium laureth sulfate, blends thereof, and any combination thereof. In some embodiments, any combination of stable and unstable soaps from these lists can be used.

Examples of combinations of foaming agents and their addition in preparation of foamed gypsum products are disclosed in U.S. Pat. No. 5,643,510, herein incorporated by reference. For example, a first foaming agent which forms a stable foam and a second foaming agent which forms an unstable foam can be combined. In some embodiments, the first foaming agent is a soap with an alkyl chain length of 8-12 carbon atoms and an alkoxy (e.g., ethoxy) group chain length of 1-4 units. The second foaming agent is optionally an unalkoxylated (e.g., unethoxylated) soap with an alkyl chain length of 6-20 carbon atoms, e.g., 6-18 carbon atoms or 6-16 carbon atoms. Regulating the respective amounts of these two soaps allows for control of the board foam structure until about 100% stable soap or about 100% unstable soap is reached.

In some embodiments, the foaming agent is in the form of an alkyl sulfate and/or alkyl ether sulfate. Such foaming agents are preferred over olefins such as olefin sulfates because the olefins contain double bonds, generally at the front of the molecule thereby making them undesirably more reactive, even when made to be a soap. Thus, preferably, the foaming agent comprises alkyl sulfate and/or alkyl ether sulfate but is essentially free of an olefin (e.g., olefin sulfate) and/or alkyne. Essentially free of olefin or alkyne means that the foaming agent contains either (i) 0 wt. % based on the weight of stucco, or no olefin and/or alkyne, or (ii) an ineffective or (iii) an immaterial amount of olefin and/or alkyne. An example of an ineffective amount is an amount below the threshold amount to achieve the intended purpose of using olefin and/or alkyne foaming agent, as one of ordinary skill in the art will appreciate. An immaterial amount may be, e.g., below about 0.001 wt. %, such as below about 0.005 wt. %, below about 0.001 wt. %, below about 0.0001 wt. %, etc., based on the weight of stucco, as one of ordinary skill in the art will appreciate.

The foaming agent is included in the gypsum slurry in any suitable amount. For example, in some embodiments, it is included in an amount of from about 0.01% to about 0.25% by weight of the stucco, e.g., from about 0.01% to about 0.1% by weight of the stucco, from about 0.01% to about 0.03% by weight of the stucco, or from about 0.07% to about 0.1% by weight of the stucco.

Foam (also known as foam water) may optionally be introduced into the gypsum low-density region slurry and/or the high-density region slurry (preferably the gypsum low-density region slurry) in amounts that provide the above mentioned reduced low-density region density and panel weight. The foaming agent to produce the foam is typically a soap or other suitable surfactant.

The gypsum slurry can optionally include at least one dispersant to enhance fluidity in some embodiments. The dispersants may be included in a dry form with other dry ingredients and/or in a liquid form with other liquid ingredients in stucco slurry. Examples of dispersants include naphthalenesulfonates, such as polynaphthalenesulfonic acid and its salts (polynaphthalenesulfonates) and derivatives, which are condensation products of naphthalenesulfonic acids and formaldehyde; as well as polycarboxylate dispersants, such as polycarboxylic ethers, for example, PCE211, PCE111, 1641, 1641F, or PCE 2641-Type Dispersants, e.g., MELFLUX 2641F, MELFLUX 2651F, MELFLUX 1641F, MELFLUX 2500L dispersants (BASF), and COATEX ETHACRYL M, available from Coatex, Inc.; and/or lignosulfonates or sulfonated lignin.

If included, the dispersant can be provided in any suitable (solids/solids) amount. In some embodiments, for example, the dispersant is present in an amount, for example, from about 0% to about 5% by weight of stucco, 0% to about 54% by weight of stucco, from about 0.05% to about 5% by weight of the stucco, from about 0.5% to about 1.5%, from about 0.05% to about 0.3% by weight of stucco, or from about 1% to about 5% by weight of stucco.

There may also be an absence of any one or more of polynaphthalenesulfonates, polycarboxylic ethers or lignosulfonates.

A water resistance or mold resistance additive such as siloxane optionally can be included. If included, the water resistance additives can be individually present in an amount from about 0.5% to about 10% by weight of the stucco. There may also be an absence of any one or more of these components for water resistance. For example, there may be an absence of siloxane.

In some embodiments, fire resistant additives optionally can be included in the gypsum slurry for forming the board. For example, the fire resistant additives can include fiber, e.g., glass fiber, carbon fiber, or mineral fiber; alumina trihydrate (ATH); and the like. If included, these additives can be present in the gypsum slurry Typical fire resistance additives are selected from one or more of high expansion particles, vermiculite, expandable graphite. If present, fire resistance additives can be included in any suitable amount as desired depending, e.g., on fire rating, and like performance parameters. For example, the fire resistance additives can be individually present in an amount of from about 0% to about 20% by weight of the stucco or in an amount from about 0.5% to about 10% by weight of the stucco. There may also be an absence of any one or more of these components for fire resistance.

### Wall Systems

In one or more other aspects of the invention, the invention provides a wall system comprising framing to which is attached at least one gypsum board of the invention, wherein the outer surface of the front cover sheet faces away from the framing. In this wall system, the gypsum board may be on an interior wall or ceiling of a building. Typically, the framing is wood or metal. Typically the at least one gypsum board is attached to the framing by any one or more of screws, nails, glue, or other mechanical fasteners.

FIG. 3 is a perspective view of a typical building wall system 30 that may be employed in a wall system of the present invention. FIG. 3 shows metal stud wall “skeleton” 32 which includes a plurality of metal studs 34, an upper track 36, a lower track 38. Gypsum boards 10 (FIG. 2) may be secured in any known manner to one or both sides of the metal studs 34 to close the wall and form the interior surface or surfaces of the wall or a ceiling. A typical metal stud wall “skeleton” may be fabricated according to U.S. Pat. No. 6,694,695 to Collins et al., incorporated herein by reference, which is suitable for combination with an exterior sheathing panel to achieve a wall system of the present invention. This metal frame system is merely provided as illustrative as wood or other metal frames may also be employed.

### Sag Test-ASTM C367M-09

Sag of the ceiling tiles can be measured according to ASTM C367M-09. Briefly, ceiling tiles are placed in a testing rack that mimics a ceiling grid. The vertical position of the geometric center of the panel as set in the rack is measured to determine the initial position of the product following a 1 hour conditioning of 70° F. (21° C.)/50% R.H. Once the initial position of the tile the panel is measured, the tile is exposed to a variety of environmental conditions that comprise a single test cycle. In particular, in the examples described below, a cycle of 12 hours at 104° F. (40° C.)/50% R.H. followed by 12 hours at 70° F. (21° C.)/50% R.H. is completed 3 times, with the center position being measured after the completion of each cycle. The sag is reported in two ways. The “Total Movement” is determined by taking the vertical position difference between the initial position of the ceiling tile and the final position of the tile after the three cycles are completed. The “Final Position” is determined by taking the final vertical position of the tile. Unless specified otherwise, sag is listed in units of inches for 2′×4′ tiles. Suitable tiles of the disclosure demonstrate less sag than uncoated tiles, for example, a sag of less than about 1.0 inch (about 2.5 cm), or less than about 0.8 inches (about 2.0 cm), or less than about 0.6 inches (about 1.5 cm), or less than about 0.5 inches (about 1.3 cm), or less than about 0.4 inches (about 1.0 cm), or less than about 0.3 inches (about 0.75 cm), or less than about 0.2 inches (about 0.50 cm), or less than about 0.1 inches (about 0.25 cm).

The following examples further illustrate the invention but, of course, should not be construed as in any way limiting its scope.

### EXAMPLES

### Example 1-Preparation of Fibrous Acoustic Panel Samples

A series of coated acoustical ceiling tiles were prepared and tested for sag resistance. Unless specified otherwise, all ceiling tiles used in the Examples are RADAR™ brand ceiling tiles available from USG Interiors, Inc. of Chicago, IL The RADAR™ brand tile is a water-felted slag wool or mineral wool fiber panel having a ⅝″ thickness and the following composition: 1-75 wt. % slag wool fiber, 5-75 wt. % expanded perlite, 1-25 wt. % cellulose, 5-15 wt. % starch, 0-15 wt. % kaolin, 0-80 wt. % calcium sulfate dehydrate, less than 2 wt. % limestone or dolomite, less than 5 wt. % crystalline silica, and less than 2 wt. % vinyl acetate polymer or ethylene vinyl acetate polymer. The diameters of the mineral wool fibers vary over a substantial range, e.g., 0.25 to 20 microns, and most of the fibers are in the range of 3 to 4 microns in diameter. The lengths of the mineral fibers range from about 1 mm to about 8 mm.

The ceiling tiles were cut and divided in 6″×24″ sample panels.

### Example 2-Sag Resistance Testing of the Coated Fibrous Panels

The panel samples were coated as listed in TABLES 1 and 2. TABLES 1 and 2 show that some of the sample panels were coated using a coating composition including an inorganic binder according to the disclosure, while others of the sample panels were coated with a comparative coating composition containing an sodium silicate but lacking a sodium polyborate or a comparative coating composition containing a sodium silicate but lacking a sodium polyborate. The coatings were applied as aqueous compositions. After all sample panels were roll coated to provide a back coating, they were dried for 2 minutes at 500° F. (about 260° C.).

The 1st coating having sodium silicate or sodium polyborate was applied to the back side of the board sample.

In some instances a coating comprising clay but no alkali metal silicate or alkali metal polyborate was applied to the front side of the panel sample simultaneously when the 1st coating having sodium silicate and/or sodium polyborate was applied to the back side.

Abbreviations in TABLES 1-4 are explained as follows:

+Facer Binder C means a clay containing composition was applied to the facer side of the building panel sample simultaneously when a coating was applied to the back side.

NaSi Binder A means a sodium silicate containing composition having composition including 18% to 30 wt. % total clay and calcium carbonate was applied to the backer side of the panel.

NaSi Binder A+Facer Binder C means a sodium silicate containing composition having including composition NaSi Binder A was applied to the backer side of the panel and a clay containing composition was applied to the facer side of the building panel sample.

NaSi Binder B means a sodium silicate containing composition having composition including 25 to 35 wt. % total clay and calcium carbonate.

NaSi Binder B+Facer Binder C means a sodium silicate containing composition having a composition NaSi Binder B was applied to the backer side of the panel and a clay containing composition was applied to the facer side of the building panel sample.

Polyborate Binder means a composition containing polyborate having an average boron number of 7 to 15. Polyborate Binder was made as follows 1). Add 50-100 g of boric acid in 500 g of 90° C. hot water and stir it to get a completely dissolved solution; 2) Slowly add 60-125 g sodium borate into the solution while stirring it until a clear solution is obtained. Dilute the solution with 500-1000 g water, then mix thoroughly to get a diluted clear polyborate (PolyB) solution with a borate weight concentration of 5-15%.

In some instances a second coating having sodium silicate or sodium polyborate was applied to the back side of the board sample. When a coating having sodium silicate was applied to the back side of the board sample and a coating having polyborate having an average boron number of 7 to 15 per molecule to the back side of the board sample they mix on the board sample and then cure to form the alkali metal polyborate silicate coating.

In some instances when the 2nd coating was applied to the back side simultaneously a coating comprising clay but no alkali metal silicate or alkali metal polyborate was applied to the front side of the panel sample.

In some instances of samples in TABLES 1 and 2, a second coating having magnesium sulfate (MS) or calcium chloride (CaCl2) or aluminum sulfate (AS) as a curing agent was applied to the back side of the board sample. For these samples, after being dried for 1-3 minutes at 350-550° F. (about 177-280° C.), the tiles were coated with the chemical curing layer and dried at 350-500° F. (about 177-260° C.) for 15-45 seconds.

The MS curing layer was applied as an aqueous solution of 5-25 wt. % magnesium sulfate and 10-22 wt. % clay.

The CaCl2 curing layer was applied as an aqueous solution of calcium chloride and clay. CaCl2 means 50 wt % of calcium chloride plus about 50 wt % of clay on dry basis of coating and typically clay.

MS+Facer Binder C means magnesium sulfate containing aqueous curing composition was applied to the backer side of the panel and an aqueous clay containing composition was applied to the facer side of the building panel sample.

Polyborate Binder+MS+Facer Binder C means an aqueous coating containing mainly Polyborate Binder and Magnesium Sulfate curing composition was applied to the backer side of the panel and an aqueous clay containing composition was applied to the facer side of the building panel sample.

Polyborate Binder+AS+Facer Binder C means an aqueous coating containing mainly Polyborate Binder and Aluminum Sulfate curing composition was applied to the backer side of the panel and an aqueous clay containing composition was applied to the facer side of the building panel sample.

When the coatings in TABLES 1 and 2 were dried and/or cured, the inorganic binder made up about 50-80 wt % of the coating, based on the total weight of the dry coating, and the inorganic filler made up about 20-50 wt % of the coating, based on the total weight of the dry coating.

In TABLES 1 and 2 Sag means the movement (inches) of the center of the tile compared to the initial portion of the center of the board; Average Sag means the average movement of the same group of samples.

These coated fibrous panels were tested for sag according to ASTM C367M-09, as described above, using 4-5 total sample panels for each coating composition. Results for the Sag test are shown in TABLES 1 and 2 wherein each reported Average Sag is an average of the four or five samples.

TABLE 1
Sag data of Acoustic (RADAR) tiles with
different coatings (wt % dry basis).

| Sample | 1st coating, | 2nd coating, | Average |
|---|---|---|---|
| # | binder, wt % | binder wt % | Sag (inches) |
| 1* | NaSi Binder A + | NaSi Binder A + | −1.235 |
| | Facer Binder C | Facer Binder C | |
| 2 | NaSi Binder B + | Polyborate Binder | −0.917 |
| | Facer Binder C | | |
| 3* | NaSi Binder A + | | −1.343 |
| | Facer Binder C | | |
| 4* | Polyborate Binder | | −1.202 |
| 5* | NaSi Binder B + | MS + Facer Binder C | −0.128 |
| | Facer Binder C | | |
| 6 | NaSi Binder B + | Polyborate Binder + | −0.086 |
| | Facer Binder C | MS + Facer Binder C | |

*Comparative example

TABLE 2
Sag data of Acoustic (RADAR) tiles with
different coatings (wt % dry basis).

| Sample | 1st coating, | 2nd coating, | Average Sag |
|---|---|---|---|
| # | binder, wt % | binder wt % | (inches) |
| 7* | NaSi Binder B + | CaCl2 + Facer Binder C | −1.138 |
| | Facer Binder C | | |
| 8 | NaSi Binder B + | Polyborate Binder + | −0.390 |
| | Facer Binder C | AS + Facer Binder C | |

*Comparative example

### Example 3—Sag Resistance Testing of the Coated Fibrous Panels

TABLES 3 and 4 present data for additional coated samples wherein each reported Average Sag is an average of six samples.

In TABLES 3 and 4 Sag means the movement (inches) of the center of the tile compared to the initial portion of the center of the board; Average Sag means the average movement of the same group of samples.

NaSi Binder B (20 g) means a coating comprising a sodium silicate containing composition having composition including 25 to 35 wt. % total clay and calcium carbonate to result in a target amount of applied dried coating of about 20 g/sq·ft. panel surface.

MS (6-10 g) means a coating comprising Magnesium Sulfate and Clay applied to result in a target amount of applied dried coating of about 8/sq·ft. panel surface.

Polyborate Binder+MS (6-10 g) means a coating containing mainly Polyborate Binder PolyB and Magnesium Sulfate was applied to the backer side of the panel to result in an amount of applied dried coating of 6-10 g for a target amount of about 8/sq·ft. panel surface.

TABLE 3
Sag data of RADAR tiles with different coatings.

| Sample | 1st coating, | 2nd coating, | Average |
|---|---|---|---|
| # | binder, wt % | binder wt % | Sag (inches) |
| 9* | NaSi Binder B (20 g) | MS (6-10 g) | −0.772 |
| 10 | NaSi Binder B (20 g) | Polyborate Binder + | −0.590 |
| | | MS (6-10 g) | |

*Comparative example

TABLE 4
Sag data of RADAR tiles with different coatings.

| | 1st coating g/sq. ft. | 2nd coating g/sq. ft. | Average |
|---|---|---|---|
| Sample | (target ~20 g/sq. ft. | (target ~8 g/sq. ft. | Sag |
| # | panel surface) | panel surface) | (inches) |
| 11* | NaSi Binder B (20 g) | MS (6-10 g) | −0.488 |
| 12 | NaSi Binder B (20 g) | Polyborate + | −0.364 |
| | | MS (6-10 g) | |

*Comparative example

As shown in Tables 1 and 2, the panels coated with a coating including a sodium polyborate silicate inorganic binder according to the disclosure, had an at least about 25% (and up to about 65%) reduction in sag, compared to the panels coated with a coating comprising only a metal silicate inorganic binder. Tables 3 and 4 showed likewise reduction.

Thus, Examples 2 and 3 demonstrate that coated fibrous panels and methods of making same, as well as curable coating compositions for improving the sag resistance of a fibrous panel, according to the disclosure. Further, Examples 2 and 3 demonstrate the coated fibrous panel of the disclosure has significantly improved sag resistance when compared to a similar coated fibrous panel lacking a polyborate salt inorganic binder.

The preceding are merely examples of the invention. It will be understood by one of ordinary skill in the art that each of these examples may be used in various combinations with the other aspects of the invention provided herein.

### Clauses of the Invention

Various aspects of the present invention are described by the following clauses:

1. A coated building panel comprising a fibrous panel or a gypsum wallboard comprising a backing side and an opposing facing side and having a cured coating layer disposed on at least one side of the building panel;
the fibrous panel comprising the backing side and the opposing facing side;
the gypsum board having a gypsum core and the backing side comprising a back fibrous cover sheet and the opposed facing side comprising a front fibrous cover sheet,
wherein the gypsum core is between the front fibrous cover sheet and the back fibrous cover sheet;
the cured coating layer comprising about 25 to 100 wt. %, preferably 30-100 wt. %, more preferably 30-80 wt. %, alkali metal polyborate silicate inorganic binder, based on the total dry weight of the cured coating.

Clause 2. The panel of clause 1, further comprising an intermediate coating layer comprising 25-100 wt % on a dry basis alkali metal silicate directly disposed on the at least one side of the building panel having the cured coating layer to be between the panel and the cured coating layer.

Clause 3. The panel of clause 1, wherein the cured coating layer is directly disposed on the at least one side of the building panel having the cured coating layer.

Clause 4. The panel of clause 1, wherein the cured (dry) coating composition comprises a mixture of alkali metal polyborate and alkali metal silicate, wherein the alkali metal polyborate is 5 to 50%, typically 10 to 50 wt. %, more typically 10-30 wt. %, of the total of the alkali metal polyborate and the alkali metal silicate.

Clause 5. The panel of clause 1, wherein the alkali metal polyborate silicate binder results from a mixture of an alkali metal polyborate and an alkali metal silicate dissolved in water.

Clause 6. The panel of clause 1, wherein the polyborate comprises a final reaction product of a boric acid compound and an alkali metal borate in water, wherein the inorganic binder is less than 5 wt. % borate other than said polyborate and less than 5 wt. % boric acid.

Clause 7. The panel of clause 1, wherein the mixture of the alkali metal polyborate and the alkali metal silicate dissolved in water is transparent.

Clause 8. The fibrous panel of clause 1, wherein the alkali metal silicate or the alkaline earth metal silicate is selected from the group consisting of sodium silicate, potassium silicate, lithium silicate, magnesium silicate, calcium silicate, beryllium silicate, and combinations thereof.

Clause 9. The fibrous panel of clause 1, wherein the polyborate salt is made from reacting a boric acid with an alkali borate selected from the group consisting of sodium metaborate, sodium tetraborate, potassium tetraborate, potassium pentaborate, ammonium pentaborate, borax decahydrate, boric oxide, lithium borate, and combinations thereof at a temperature in a range of 175 to 195° F.

Clause 10. The fibrous panel of clause 1, wherein the inorganic binder comprises sodium silicate and the polyborate, wherein the polyborate comprises a final reaction product of the boric acid compound and sodium tetraborate.

Clause 11. The fibrous panel of clause 1, wherein the coating layer further comprises up to 75 wt. %, typically up to 65 wt %, inorganic filler based on the total weight of the dry coating, and the inorganic binder and the inorganic filler are not the same.

Clause 12. The fibrous panel of clause 11, wherein the inorganic filler is selected from the group consisting of clay, mica, sand, barium sulfate, silica, talc, aragonite, magnesia, olivine, dolomite, tremolite, xonolite, vermiculite, gypsum, perlite, limestone (calcite or aragonite), magnesite, wollastonite, zinc oxide, zinc sulfate, hollow beads, bentonite salts, fly ash, bottom ash, coal ash, steel slag, iron slag, limestone slag, zeolite, and combinations thereof.

Clause 13. A method of making the coated building panel of any of clauses 1 to 12, comprising:
providing the building panel comprising a backing side and an opposing facing side, and
depositing a first coating layer of an aqueous coating composition comprising an inorganic alkali metal polyborate silicate binder dissolved in water on at least one side of the building panel selected from the backing side and the opposing facing side, the inorganic alkali metal polyborate silicate binder comprising a mixture of an inorganic alkali metal polyborate and an inorganic alkali metal silicate,
curing the coating layer of the aqueous coating composition comprising the inorganic alkali metal polyborate silicate binder to form a cured coating layer comprising the inorganic alkali metal polyborate silicate binder;
the cured coating layer comprising about 25 to 100 wt. %, preferably 30-100 wt. %, more preferably 30-80 wt. %, alkali metal polyborate silicate inorganic binder, based on the total dry weight of the cured coating.

Clause 14. The method of clause 13, wherein the cured (dry) coating composition comprises a mixture of alkali metal polyborate and alkali metal silicate, wherein the alkali metal polyborate is 5 to 50%, typically 10 to 50 wt. %, more typically 10-30 wt. %, of the total of the alkali metal polyborate and the alkali metal silicate.

Clause 15. The method of clause 13, wherein the polyborate comprises a final reaction product of a boric acid compound and an alkali metal borate in water, wherein the inorganic binder is less than 5 wt. % borate other than said polyborate and less than 5 wt. % boric acid; and
wherein the inorganic binder is water soluble and transparent.

Clause 16. The method of clause 13, wherein the first coating layer is deposited by depositing a composition comprising the alkali metal polyborate and the alkali metal silicate to form the cured coating layer comprising the inorganic alkali metal polyborate silicate binder.

Clause 17. The method of clause 13, wherein the first coating layer is deposited by depositing a composition comprising the alkali metal polyborate and depositing a composition comprising the alkali metal silicate to mix on the building panel to form the cured coating layer comprising the inorganic alkali metal polyborate silicate binder.

Clause 18. The method of clause 13, further comprising:
depositing directly on the building panel an intermediate coating layer aqueous composition comprising 25-100 wt % on a dry basis alkali metal silicate directly disposed on the at least one side of the building panel prior to depositing the aqueous coating composition comprising the inorganic alkali metal polyborate silicate binder dissolved in water on the at least one side of the building panel.

Clause 19. The method of clause 13,
wherein a composition comprising the alkali metal silicate and a composition comprising the alkali metal polyborate are individually deposited on the building panel to mix on the at least one side of the building panel and form the aqueous coating composition comprising the inorganic alkali metal polyborate silicate binder for the first coating layer,
optionally further comprising, prior to depositing the inorganic alkali metal polyborate silicate binder dissolved in water on the at least one side of the building panel, depositing directly on the at least one side of the building panel an intermediate coating layer aqueous composition comprising 25-100 wt % on a dry basis alkali metal silicate, and curing the intermediate coating layer composition.

Clause 20. The method of clause 13, further comprising:
depositing directly on the cured first coating layer a second coating layer of an aqueous coating composition comprising an inorganic alkali metal polyborate silicate binder dissolved in water on at least one side of the building panel, the inorganic alkali metal polyborate silicate binder comprising a mixture of an inorganic alkali metal polyborate and an inorganic alkali metal silicate,
curing the second coating layer of the aqueous coating composition comprising the inorganic alkali metal polyborate silicate binder to form a second cured coating layer comprising the inorganic alkali metal polyborate silicate binder;
wherein the inorganic alkali metal polyborate silicate binder is about 25 to 100 wt. %, preferably 30-100 wt. %, more preferably 30-80 wt. %, of the total weight of the second cured coating layer.

Clause 21. The method of clause 20, wherein second coating layer further comprises an inorganic filler, wherein the inorganic filler is present in an amount up to 75 wt. %, typically up to 65 wt. %, based on the weight of the dry second coating layer, and the inorganic binder and inorganic filler are not the same.

Clause 22. The method of clause 13, further comprising depositing a chemical curing layer.

Clause 23. The method of clause 22, wherein the chemical curing layer comprises a solution of a multivalent metal or acid.

Clause 24. The method of clause 23, wherein the solution of the multivalent metal or acid comprises a metal salt comprising a cation selected from the group consisting of beryllium, calcium, magnesium, strontium, barium, zinc, iron, aluminum, and combinations thereof.

Clause 25. The method of clause 23, wherein the solution of the multivalent metal or acid further comprises clay, mica, sand, barium sulfate, silica, talc, aragonite, magnesia, olivine, dolomite, tremolite, xonolite, vermiculite, gypsum, perlite, limestone (calcite or aragonite), magnesite, wollastonite, zinc oxide, zinc sulfate, hollow beads, bentonite salts, fly ash, bottom ash, coal ash, steel slag, iron slag, limestone slag, zeolite, and combinations thereof.

Clause 26. The method of clause 22, wherein the chemical curing layer comprises calcium chloride and clay.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

All references cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. “Bonding relation” does not mean that two layers are in direct contact. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Unless otherwise indicated, all percentages, ratios, and average molecular weights are on a weight basis.

1. A coated building panel comprising a fibrous panel or a gypsum wallboard comprising a backing side and an opposing facing side and having a cured coating layer disposed on at least one side of the building panel;
the fibrous panel comprising the backing side and the opposing facing side;
the gypsum board having a gypsum core and the backing side comprising a back fibrous cover sheet and the opposed facing side comprising a front cover sheet, wherein the gypsum core is between the front fibrous cover sheet and the back fibrous cover sheet;
the cured coating layer comprising about 25 to 100 wt. % alkali metal polyborate silicate inorganic binder, based on the total dry weight of the cured coating.

2. The coated building panel of claim 1, further comprising an intermediate coating layer comprising 25-100 wt % on a dry basis alkali metal silicate directly disposed on the at least one side of the building panel having the cured coating layer to be between the panel and the cured coating layer.

3. The coated building panel of claim 1, wherein the cured coating layer is directly disposed on the at least one side of the building panel having the cured coating layer.

4. The coated building panel of claim 1, wherein the cured coating composition comprises a mixture of alkali metal polyborate and alkali metal silicate, wherein the alkali metal polyborate is 5 to 50% of the total of the alkali metal polyborate and the alkali metal silicate.

5. The coated building panel of claim 1, wherein the alkali metal polyborate silicate binder results from a mixture of an alkali metal polyborate and an alkali metal silicate dissolved in water.

6. The coated building panel of claim 1, wherein the polyborate comprises a final reaction product of a boric acid compound and an alkali metal borate in water, wherein the inorganic binder is less than 5 wt. % borate other than said polyborate and less than 5 wt. % boric acid.

7. The coated building panel of claim 1, wherein the mixture of the alkali metal polyborate and the alkali metal silicate dissolved in water is transparent.

8. The coated building panel of claim 1, wherein the alkali metal silicate is selected from the group consisting of sodium silicate, potassium silicate, lithium silicate, and combinations thereof.

9. The coated building panel of claim 1, wherein the polyborate salt is made from reacting a boric acid with an alkali borate selected from the group consisting of sodium metaborate, sodium tetraborate, potassium tetraborate, potassium pentaborate, ammonium pentaborate, borax decahydrate, boric oxide, lithium borate, and combinations thereof at a temperature in a range of 175 to 195° F.

10. The coated building panel of claim 1, wherein the inorganic binder comprises sodium silicate and the polyborate, wherein the polyborate comprises a final reaction product of the boric acid compound and sodium tetraborate.

11. The coated building panel of claim 1, wherein the coating layer further comprises up to 75 wt. % inorganic filler based on the total weight of the dry coating, and the inorganic binder and the inorganic filler are not the same.

12. The coated building panel of claim 11, wherein the inorganic filler is selected from the group consisting of clay, mica, sand, barium sulfate, silica, talc, aragonite, magnesia, olivine, dolomite, tremolite, xonolite, vermiculite, gypsum, perlite, limestone, magnesite, wollastonite, zinc oxide, zinc sulfate, hollow beads, bentonite salts, fly ash, bottom ash, coal ash, steel slag, iron slag, limestone slag, zeolite, and combinations thereof.

13. A method of making the coated building panel of claim 1, comprising:
providing the building panel comprising a backing side and an opposing facing side, and
depositing a first coating layer of an aqueous coating composition comprising an inorganic alkali metal polyborate silicate binder dissolved in water on at least one side of the building panel selected from the backing side and the opposing facing side, the inorganic alkali metal polyborate silicate binder comprising a mixture of an inorganic alkali metal polyborate and an inorganic alkali metal silicate,
curing the coating layer of the aqueous coating composition comprising the inorganic alkali metal polyborate silicate binder to form a cured coating layer comprising the inorganic alkali metal polyborate silicate binder;
the cured coating layer comprising about 25 to 100 wt. % alkali metal polyborate silicate inorganic binder, based on the total dry weight of the cured coating.

14. The method of claim 13, wherein the cured coating composition comprises a mixture of alkali metal polyborate and alkali metal silicate,
wherein the alkali metal polyborate is 5 to 50% of the total of the alkali metal polyborate and the alkali metal silicate.

15. The method of claim 13, wherein the polyborate comprises a final reaction product of a boric acid compound and an alkali metal borate in water, wherein the inorganic binder is less than 5 wt. % borate other than said polyborate and less than 5 wt. % boric acid; and
wherein the inorganic binder is water soluble and transparent.

16. The method of claim 13, wherein the first coating layer is deposited by depositing a composition comprising the alkali metal polyborate and the alkali metal silicate to form the cured coating layer comprising the inorganic alkali metal polyborate silicate binder.

17. The method of claim 13, wherein the first coating layer is deposited by depositing a composition comprising the alkali metal polyborate and depositing a composition comprising the alkali metal silicate to mix on the building panel to form the cured coating layer comprising the inorganic alkali metal polyborate silicate binder.

18. The method of claim 13, further comprising:
depositing directly on the building panel an intermediate coating layer aqueous composition comprising 25-100 wt % on a dry basis alkali metal silicate directly disposed on the at least one side of the building panel prior to depositing the aqueous coating composition comprising the inorganic alkali metal polyborate silicate binder dissolved in water on the at least one side of the building panel.

19. The method of claim 13,
wherein a composition comprising the alkali metal silicate and a composition comprising the alkali metal polyborate are individually deposited on the building panel to mix on the at least one side of the building panel and form the aqueous coating composition comprising the inorganic alkali metal polyborate silicate binder for the first coating layer,
optionally further comprising, prior to depositing the inorganic alkali metal polyborate silicate binder dissolved in water on the at least one side of the building panel, depositing directly on the at least one side of the building panel an intermediate coating layer aqueous composition comprising 25-100 wt % on a dry basis alkali metal silicate, and curing the intermediate coating layer composition.

20. The method of claim 13, further comprising:
depositing directly on the cured first coating layer a second coating layer of an aqueous coating composition comprising an inorganic alkali metal polyborate silicate binder dissolved in water on at least one side of the building panel, the inorganic alkali metal polyborate silicate binder comprising a mixture of an inorganic alkali metal polyborate and an inorganic alkali metal silicate,
curing the second coating layer of the aqueous coating composition comprising the inorganic alkali metal polyborate silicate binder to form a second cured coating layer comprising the inorganic alkali metal polyborate silicate binder;
wherein the inorganic alkali metal polyborate silicate binder is about 25 to 100 wt. % of the total weight of the second cured coating layer.

21-26. (canceled)
